(19) United States
(12) Patent Application Publication
(10) Pub. No.: US 2015/0262460 A1
(43) Pub. Date: Sep. 17, 2015

(54) MONITORING METHOD AND MONITORING APPARATUS

(71) Applicant: FUJITSU LIMITED, Kawasaki-shi (JP)

(72) Inventor: Fumito ITO, Kita (JP)

(21) Appl. No.: 14/619,255

(22) Filed: Feb. 11, 2015

(30) Foreign Application Priority Data
Mar. 13, 2014 (JP) 2014-050418

(51) Int. Cl. G08B 13/22

(52) U.S. Cl. CPC G08B 13/22

(57) ABSTRACT

A monitoring apparatus acquires a first piece of information indicating a detection result of whether or not an item placed in an item placement area has been moved, and a second piece of information indicating a detection result of a direction of a person located around the item placement area and determines whether or not to output warning information, based on the first piece of information and the second piece of information. It is possible to accurately monitor occurrence of a special situation such as shoplifting which is different from a normal case where a person takes an item in hand with the purpose of purchasing the same.

### CROSS-REFERENCE TO RELATED APPLICATION

This application is based upon and claims the benefit of priority of the prior Japanese Patent Application No. 2014-050418, filed on Mar. 13, 2014, the entire contents of which are incorporated herein by reference.

### FIELD

The embodiments discussed herein relate to a monitoring method and a monitoring apparatus.

### BACKGROUND

In late years, a technique of determining the situation in a store using image data or sensor data is drawing attention. For example, there is proposed a technique which determines a degree of suspiciousness of a person based on an image of the person detected from a monitored image, stores the image of the person together with the degree of suspiciousness which has been set for the image of the person, and outputs a warning when an image of a person whose stored degree of suspiciousness is equal to or more than a predetermined value matches the image of the person detected from the monitored image.

In addition, for example, there is proposed a technique which installs, in each item placement area, a sensor for detecting that a person has stretched out his/her hand to an item and transmits detection information to an analysis server, upon detection by the sensor that the person has stretched out his/her hand to an item.
Japanese Laid-Open Patent Publication No. 2009-246799
Japanese Laid-Open Patent Publication No. 2009-98929

A sales clerk of a store, when having noticed that a customer has stopped near an item and faced the direction of the item, may predict that the customer will take the item in hand. In addition, when the sensor has detected that an item being exhibited has been moved, the sales clerk may also guess that a customer has taken the item in hand. The sales clerk, when having determined that the customer has taken the item in hand, may guess that the item will be purchased, and determine the next action to do such as heading for the cash register.

However, occurrence of a situation that an item being exhibited has been moved, or a situation that a customer takes an item in hand is not limited to the case where the customer has behaved with the purpose of purchasing the item. For example, there may be conceivable a case where an item has been taken away by a criminal act such as shoplifting, or a case where a part of the customer's baggage or body has unintentionally contacted an item. However, it has been difficult for the sales clerk to determine such a detailed situation of the item.

### SUMMARY

According to an aspect, there is provided a monitoring method including: acquiring, by an information processing apparatus, a first piece of information indicating a detection result of whether or not an item placed in an item placement area has been moved, and a second piece of information indicating a detection result of a direction of a person located around the item placement area; and determining, by the information processing apparatus, whether or not to output warning information, based on the first piece of information and the second piece of information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of a monitoring apparatus of a first embodiment and an exemplary processing thereby;

FIG. 2 illustrates an example of an exhibition management system of a second embodiment;

FIG. 3 illustrates an exemplary placement of a sensor device;

FIG. 4 illustrates an exemplary hardware configuration of the sensor device;

FIG. 5 illustrates an exemplary hardware configuration of an exhibition management apparatus;

FIG. 6 illustrates an exemplary hardware configuration of a terminal apparatus;

FIG. 7 illustrates an exemplary determination of whether an item exists in an item placement area;

FIG. 8 illustrates an exemplary determination of whether a position of an item has been moved from a proper position on an item placement area;

FIG. 9 illustrates an exemplary determination of whether a customer has reached out his/her hand to an item;

FIG. 10 illustrates exemplary functions of the sensor device, the exhibition management apparatus, and the terminal apparatus;

FIG. 11 illustrates an example of skeletal information;

FIG. 12 illustrates an exemplary area information table;

FIG. 13 illustrates an exemplary item information table;

FIG. 14 illustrates an exemplary message information table;

FIG. 15 illustrates an exemplary item situation setting table;

FIG. 16 illustrates an exemplary display of a first message;

FIG. 17 illustrates an exemplary display of a second message;

FIG. 18 illustrates an exemplary display of a third message;

FIG. 19 illustrates an exemplary display of a fourth message;

FIG. 20 is a flowchart illustrating an exemplary procedure of controlling output of a message;

FIG. 21 is a flowchart illustrating an exemplary procedure of determining a message;

FIG. 22 is a flowchart illustrating the exemplary procedure of determining a message (continuation); and

FIG. 23 is a flowchart illustrating the exemplary procedure of determining a message (continuation-2).

### DESCRIPTION OF EMBODIMENTS

Several embodiments will be described below with reference to the accompanying drawings, wherein like reference numerals refer to like elements throughout.

### First Embodiment

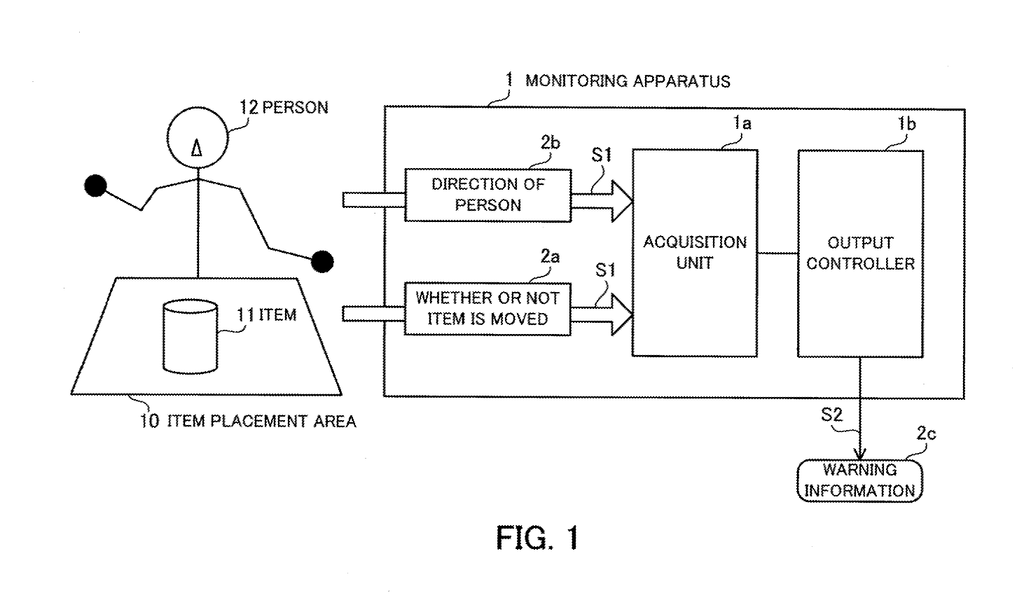

FIG. 1 illustrates an exemplary configuration of a monitoring apparatus of a first embodiment and an exemplary processing thereby. A monitoring apparatus 1 is an apparatus configured to monitor the situation of an item 11 placed in an item placement area 10, or the situation of a person 12 located around the item placement area 10. The monitoring apparatus 1 is implemented as a computer, for example. In this case, the monitoring apparatus 1 may be a desktop computer, for example, or a notebook computer. In addition, for example, the person 12 being monitored is a customer who is visiting a store in which the item 11 is being exhibited.

The monitoring apparatus 1 has an acquisition unit 1a and an output controller 1b. Each processing by the acquisition unit 1a and the output controller 1b is implemented, for example, by executing a predetermined program by a processor included in the monitoring apparatus 1.

The acquisition unit 1a acquires a first piece of information 2a indicating the detection result of whether or not the item 11 placed in the item placement area 10 has been moved, and a second piece of information 2b indicating the detection result of a direction of the person 12 located around the item placement area 10 (step S1). The first piece of information 2a and the second piece of information 2b may be acquired from another apparatus or a storage medium, or may be acquired by analyzing an image or sensor data.

The output controller 1b determines whether or not to output warning information 2c, based on the first piece of information 2a and the second piece of information 2b (step S2). The warning information 2c may be, for example, information indicating the situation of the item 11 being exhibited, information indicating precautions and actions to be taken according to the situation, and the cause of the situation, or the like. In addition, the output of the warning information 2c may be implemented by causing the display provided in the monitoring apparatus 1 to display the contents of the warning information 2c, for example. Alternatively, the monitoring apparatus 1 may transmit the warning information 2c to a computer (e.g., a mobile terminal apparatus held by a sales clerk) which is communicable with the monitoring apparatus 1. In this case, the contents of the transmitted warning information 2c may be displayed on the display of the mobile terminal apparatus.

According to the monitoring apparatus 1, whether or not to output the warning information 2c is determined, based on whether or not the item 11 has been moved and the direction of the person 12 located around the item placement area 10. Accordingly, the situation of the item 11 being exhibited may be accurately monitored. Then, a user (e.g., a sales clerk of a store) who has recognized the warning information 2c thus output may accurately recognize the situation of the item 11 being exhibited. For example, the user may determine the detailed situation besides simply whether or not the item 11 has been moved.

For example, in a case (first case) where the person 12 moves, taking the item 11 in hand with the purpose of purchasing the same, it is very likely that the person 12 is facing the direction of the item placement area 10 when it is detected that the item 11 has been moved. On the other hand, in a case (second case) where the person 12 is not facing the direction of the item placement area 10 when it is detected that the item 11 has been moved, it is very unlikely that the item 11 has been moved because the person 12 has taken the item 11 in hand with the purpose of purchasing the same.

It is conceivable, as an exemplary cause of movement of the item 11 in the second case, that the item 11 has been taken away by a criminal act such as shoplifting, or a baggage owned by the person 12 or a part of body of the person 12 has unintentionally contacted the item 11. Such a situation is difficult for the sales clerk of the store to notice unless the sales clerk is always monitoring the behavior of the person 12 closely. In addition, it is conceivable that the sales clerk of the store is expected to take a different action from the first case when the second case occurs.

For example, the output controller 1b may output the warning information 2c when the item 11 has been moved and the person 12 is not facing the direction of the item placement area 10, whereby the user who has recognized the warning information 2c may recognize that the second case has occurred. Accordingly, the user is able to not only recognize that the item 11 has been moved but also recognize that the cause of movement is not because the person 12 has taken the item 11 in hand with the purpose of purchasing the same.

In addition, when it is detected that the item 11 has been moved, the output controller 1b may change the contents of the warning information 2c to be output, according to the detection result of the direction the person 12 is facing. Accordingly, the user is able to not only recognize that the item 11 has been moved, but also determine the cause of movement.

### Second Embodiment

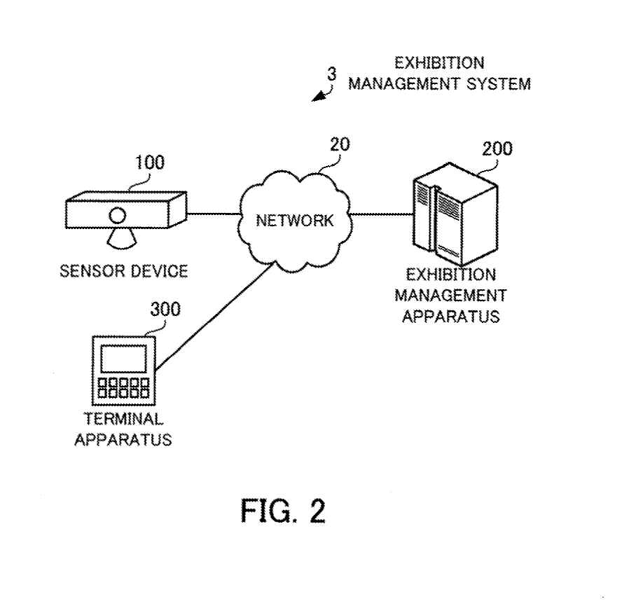

FIG. 2 illustrates an exemplary exhibition management system of a second embodiment. An exhibition management system 3 is a system in which there is newly added, to a system which determines occurrence of disarray in exhibition of an item, a function of determining the situation of the item under a special situation such that the position of the item has moved although a customer is not facing the direction of the item. As an example of the aforementioned special situation, there may be a case where the position of an item has been moved due to contact between the customer's baggage and the item, or a case where an item has been taken away by a criminal act (e.g., shoplifting) committed on the item by a customer.

The exhibition management system 3 has a sensor device 100, an exhibition management apparatus 200, and a terminal apparatus 300. The exhibition management apparatus 200 is connected to the sensor device 100 and the terminal apparatus 300 via a network 20. The number of sensor devices may be two or more. In addition, the sensor device 100 and the exhibition management apparatus 200 are installed in the store where items are being sold. Alternatively, only the sensor device 100 may be installed in the store, and the exhibition management apparatus 200 may be installed outside the store. The exhibition management apparatus 200 is an example of the monitoring apparatus 1 of the first embodiment.

The sensor device 100 has an image capturing function. The sensor device 100 captures an image of at least an area in which items are placed at a predetermined time interval ( 1/30 seconds, for example) among the areas inside the store. An area of the store shelf on which items are being placed may be an exemplary area in which items are being placed.

In addition, the sensor device 100 detects skeletal information of the person (customer, in this case) appearing in the image. In the present embodiment, the sensor device 100 detects at least a wrist as a region of the skeleton of the customer. In addition, the skeletal information includes position information of a corresponding region of the skeleton. The position information includes a position and a depth in an image for each region of the skeleton. The depth refers to the distance from the sensor device 100 to the subject for each pixel.

The sensor device 100 transmits data of the captured image and the detected skeletal information to the exhibition management apparatus 200. The sensor device 100 transmits these pieces of information to the exhibition management apparatus 200 at a predetermined time interval. The sensor device 100 may transmit information indicating the depth of an image for each pixel to the exhibition management apparatus 200 together with the image data or the like.

The exhibition management apparatus 200 is a computer configured to determine the situation of an item and output information indicating the situation. Each time receiving image data and skeletal information from the sensor device 100, the exhibition management apparatus 200 analyzes the received image data or skeletal information, and determines the situation of the item. The situation of an item may include, for example, that a customer has moved from an area where the sensor device 100 captures an image with the position of an item moved from a predetermined position, or that a customer has moved from an area where the sensor device 100 captures an image, taking an item in hand with the purpose of purchasing the same. Alternatively, as another example, the situation may include that an item has been taken away by a criminal act such as shoplifting, or that an item has fallen because a customer's baggage or the like has contacted the item. The situation of an item is determined by whether the position of an item has been moved, whether a customer has reached out his/her hand to an item, or the direction of the customer.

The exhibition management apparatus 200 generates a message related to the situation of an item, and transmits it to the terminal apparatus 300.

The terminal apparatus 300 is an apparatus held by a sales clerk being in a store. The terminal apparatus 300 receives a message indicating the situation of an item from the exhibition management apparatus 200, and displays it on the display.

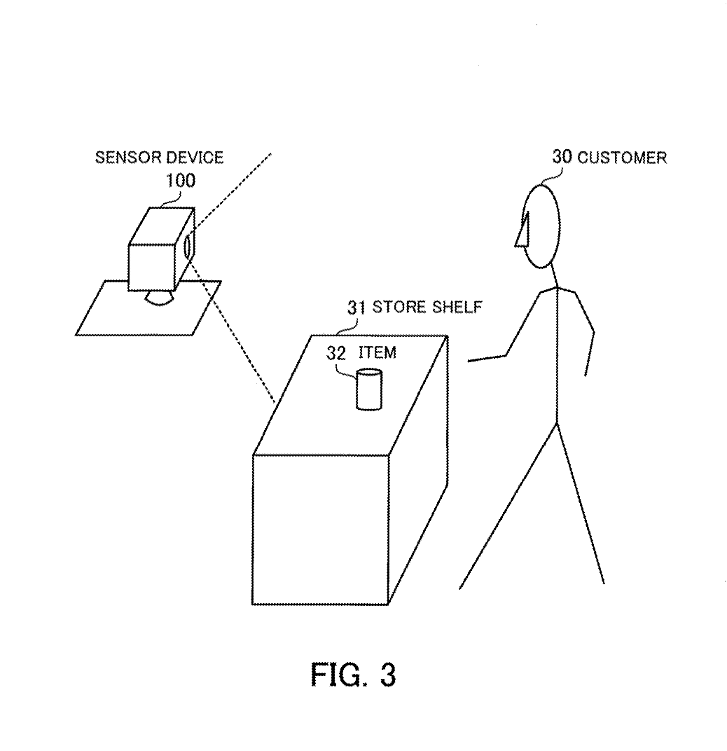

FIG. 3 illustrates an exemplary placement of a sensor device. In the example of FIG. 3, an item 32 is placed on the top of a store shelf 31. In addition, the right-hand side of FIG. 3 is an area where a customer 30 moves. The sensor device 100 is installed on the store shelf 31 at a position opposite to the moving area of the customer 30. In this case, the sensor device 100 is supposed to transmit, to the exhibition management apparatus 200, data of an image with the customer 30, the store shelf 31, and the item 32 being subjects, and skeletal information of the customer 30.

Such a placement method of the sensor device 100 allows the exhibition management apparatus 200 to accurately monitor the situation of the area on the store shelf 31 on which the item 32 is placed, based on the information received from the sensor device 100.

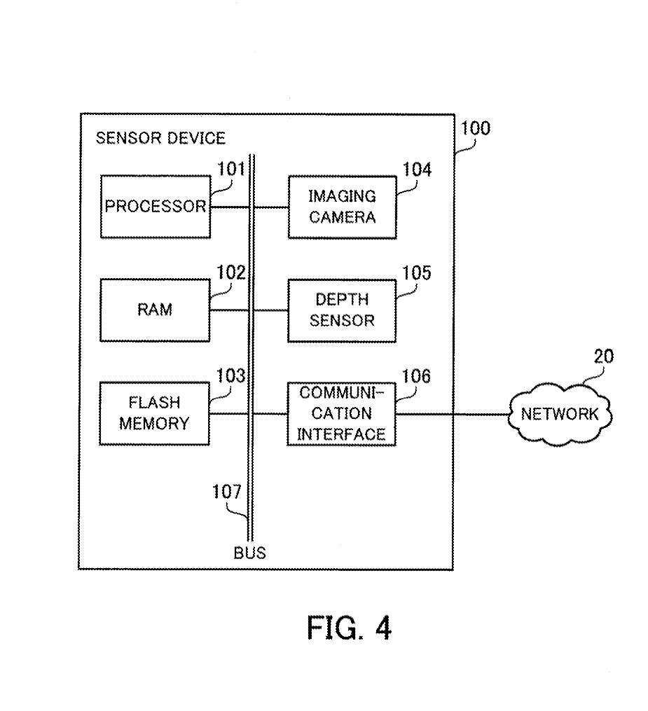

FIG. 4 illustrates an exemplary hardware configuration of the sensor device. The sensor device 100 has a processor 101, a RAM (Random Access Memory) 102, a flash memory 103, an imaging camera 104, a depth sensor 105, and a communication interface 106. The units are connected to a bus 107 in the sensor device 100.

The processor 101 includes a computing unit configured to execute program instructions, and is a CPU (Central Processing Unit), for example. The processor 101 loads at least a part of programs or data stored in the flash memory 103 to the RAM 102, and executes the program. The processor 101 may include a plurality of processor cores. In addition, the sensor device 100 may include a plurality of processors. In addition, the sensor device 100 may perform parallel processing using a plurality of processors or a plurality of processor cores. In addition, a set of two or more processors, a dedicated circuit such as an FPGA (Field Programmable Gate Array) or an ASIC (Application Specific Integrated Circuit), a set of two or more dedicated circuits, a combination of a processor and a dedicated circuit may be referred to as a “processor”.

The RAM 102 is a volatile memory configured to temporarily store a program to be executed by the processor 101 or data to be referred to from the program. The sensor device 100 may include a memory of a type other than the RAM, and may include a plurality of volatile memories.

The flash memory 103 is a nonvolatile storage device configured to store programs such as the firmware or application software, and data. The sensor device 100 may include other types of storage device such as an HDD (Hard Disk Drive), and may include a plurality of nonvolatile storage devices.

The imaging camera 104 captures images and output data of the captured images to the processor 101.

The depth sensor 105 measures the depth for each pixel of an image captured by the imaging camera 104, and outputs it to the processor 101. TOF (Time Of Flight) method which measures the depth based on the round-trip time of laser beam may be employed as the depth measurement method, for example. In addition, a variety of measurement methods, such as pattern irradiation method which measures the depth based on the distortion of patterns of reflected light beams (e.g., infrared light) may be used as another measurement method, any of which may be employed. When TOF method or pattern irradiation method is employed, the depth sensor 105 has a light beam irradiation device of a laser beam, an infrared light, or the like, and a sensor which detects reflected components of an irradiated light beam.

The communication interface 106 communicates with other information processing apparatuses (e.g., exhibition management device 200) via a network such as the network 20.

The program to be executed by the processor 101 may be copied from other storage devices to the flash memory 103. In addition, the sensor device 100 is not limited to the aforementioned configuration as long as it is capable of detecting the position and depth of a region of a human body in the captured image.

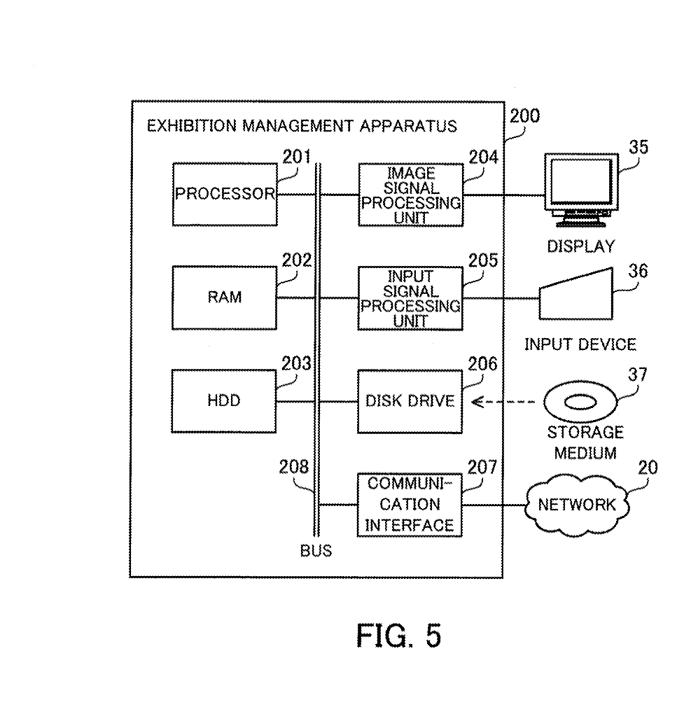

FIG. 5 illustrates an exemplary hardware configuration of the exhibition management apparatus. The exhibition management apparatus 200 has a processor 201, a RAM 202, an HDD 203, an image signal processing unit 204, an input signal processing unit 205, a disk drive 206, and a communication interface 207. The units are connected to a bus 208 in the exhibition management apparatus 200.

The processor 201 includes a computing unit configured to execute program instructions, similarly to the aforementioned processor 101. The RAM 202 is a volatile memory configured to temporarily store programs to be executed by the processor 201 and data, similarly to the aforementioned RAM 102.

The HDD 203 is a nonvolatile storage device configured to store programs of software such as the OS (Operating System), the firmware and application software, and data. The exhibition management apparatus 200 may include other types of storage device such as a flash memory, and may include a plurality of nonvolatile storage devices.

The image signal processing unit 204 outputs an image to a display 35 connected to the exhibition management apparatus 200, according to an instruction from the processor 201. A liquid crystal display (LCD), an organic EL (Electro Luminescence), or the like may be used as the display 35.

The input signal processing unit 205 acquires an input signal from an input device 36 connected to the exhibition management apparatus 200, and notifies it to the processor 201. A pointing device such as a mouse or a touch panel, a keyboard or the like may be used as the input device 36.

The disk drive 206 is a drive unit configured to read programs or data stored in a storage medium 37. A magnetic disk such as a flexible disk (FD) or an HDD, an optical disk such as a CD (Compact Disc) or a DVD (Digital Versatile Disc), and a Magneto-Optical disk (MO), for example, may be used as the storage medium 37. The disk drive 206 stores programs or data read from the storage medium 37 in the RAM 202 or the HDD 203, according to an instruction from the processor 201.

The communication interface 207 communicates with other information processing apparatuses (e.g., sensor device 100) via a network such as the network 20.

The exhibition management apparatus 200 need not necessarily include the disk drive 206 and, when being mostly controlled by another terminal apparatus, need not include the image signal processing unit 204 and the input signal processing unit 205. In addition, the display 35 and the input device 36 may be integrally formed with the housing of the exhibition management apparatus 200.

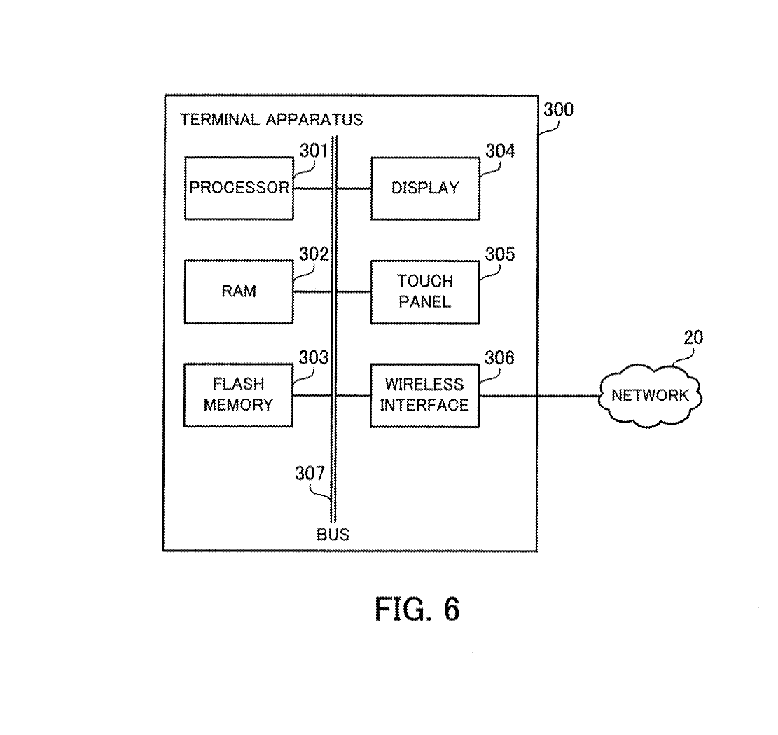

FIG. 6 illustrates an exemplary hardware configuration of the terminal apparatus. The terminal apparatus 300 has a processor 301, a RAM 302, a flash memory 303, a display 304, a touch panel 305, and a wireless interface 306. The units are connected to a bus 307 in the terminal apparatus 300.

The processor 301 is a processor including a computing unit configured to execute program instructions, similarly to the aforementioned processor 101. The RAM 302 is a volatile memory configured to temporarily store a program to be executed by the processor 301 and data, similarly to the aforementioned RAM 102.

The flash memory 303 is a nonvolatile storage device configured to store programs such as the OS, the firmware and application software, and data. The terminal apparatus 300 may include other types of storage device such as an HDD, and may include a plurality of nonvolatile storage devices.

The display 304 displays an image according to an instruction from the processor 301. A liquid crystal display or an organic EL display may be used as the display 304.

The touch panel 305, overlaid on the display 304, detects the user's touch operation on the display 304, and notifies the processor 301 of the touch position as an input signal. A pointing device such as a touch pen or the user's finger is used for touch operations. There are a variety of detection methods using a matrix switch, a resistive film, a surface elastic waves, an infrared light, electromagnetic induction, electrostatic capacitance, any of which may be used as the method of detecting touch positions. The terminal apparatus 300 may include other types of input device such as a keypad provided with a plurality of input keys.

The wireless interface 306 is a communication interface configured to perform wireless communication. The wireless interface 306 performs demodulation/decoding of received signals, encoding/modulation of transmission signals and the like. For example, the wireless interface 306 connects to the network 20 etc. via an access point (not illustrated). The terminal apparatus 300 may include a plurality of wireless interfaces.

The program to be executed by the processor 301 may be copied from other storage devices to the flash memory 303. In addition, the program to be executed by the processor 301 may be downloaded from the network 20 or the like by the wireless interface 306.

Next, a method of determining the situation of an item will be described. The exhibition management apparatus 200 determines the situation of an item by whether the position of the item has been moved, whether a customer has reached out his/her hand to the item, and whether the customer's face is facing the direction of an item placement area.

An item placement area, which means a certain space in which a predetermined item is placed, is used for determining, for example, whether a customer has reached out his/her hand to the item. For example, an item placement area refers to an area and a space up to a certain height thereabove in which a predetermined item is placed on the top of a store shelf.

However, the process of determining entrance of a hand into such a 3-dimensional space is complicated. Accordingly, the exhibition management apparatus 200 sets, in an image, a 2-dimensional area corresponding to the item placement area, and determines whether the customer's hand (e.g., representative position of the wrist) has entered the 2-dimensional area, depending on whether the hand is included in the set item placement area. In the following, a 2-dimensional area which is set in an image and corresponds to an item placement area may be referred to as a “set area”.

For example, a determination method based on the position of the customer's shoulders included in the skeletal information received from the sensor device 100 may be used as the method of determining the direction of the customer. In the method, it is determined, for example, that the customer is facing the direction of the sensor device 100 (i.e., the direction of an item) when the distance between the customer's shoulders is larger than a threshold. Additionally, for example, when the position of the customer's wrist has been detected (i.e., the wrist is not blocked by the customer's body), or when the depth of the customer's wrist is smaller than the depth of the shoulder connected to the wrist, besides the distance between the customer's shoulders being larger than the threshold, it may be determined that the customer is facing the direction of the sensor device 100.

In addition, a method which determines that the customer is facing the direction of the sensor device 100 when the distance from the sensor device 100 to the customer's head is shorter than the distance from the sensor device 100 to the customer's neck may be used as another method of determining the direction of the customer. As a still another determination method, there may be a method which extracts an area indicating the customer from an image received from the sensor device 100 and analyzes the extracted area, and thereby determines the direction of the customer. For example, there is a method which determines the direction of the customer based on the position of parts of the face (eye, nose, etc.) in the area indicating the customer.

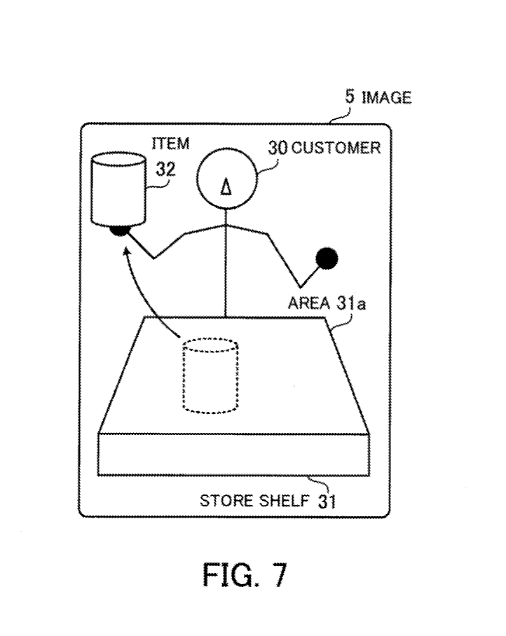

A method of determining whether the position of an item has been moved, and a method of determining whether a customer has reached out his/her hand to an item will be described, referring to FIGS. 7 to 9.

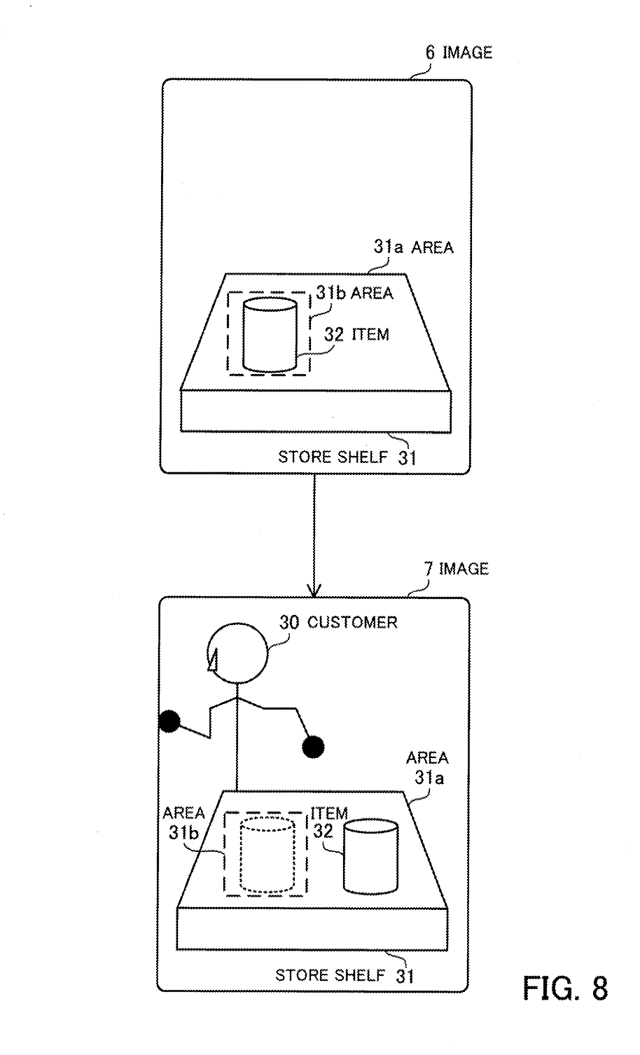

First, the method of determining whether or not an item has been moved will be described, referring to FIGS. 7 and 8. The exhibition management apparatus 200 has an image of an item preliminarily stored therein. In addition, before starting monitoring the situation of an item after the item is exhibited, the exhibition management apparatus 200 acquires an image captured with the item being properly exhibited in the item placement area, then acquires and stores information indicating the image area of the item appearing in the acquired image.

A state that an item has been moved includes a state that the item is no longer existing in the item placement area, and a state that the position of the item has been moved from the proper position in the item placement area. When an image that matches a preliminarily stored image of the item is detected in the image of the set area corresponding to the item placement area among the images received from the sensor device 100, the exhibition management apparatus 200 determines that the item exists in the item placement area, or determines that the item does not exists in the item placement area when no image matching the image of the item has been detected.

In addition, when it is determined that the item exists in the item placement area by comparison with a preliminarily stored image of the item, the exhibition management apparatus 200 first acquires the image area of the detected item. When the image area of the detected item does not match the image area of the item when being properly exhibited, it is determined that the position of the item placed in the item placement area has been moved from the position when being properly exhibited.

FIG. 7 illustrates an exemplary determination of whether an item exists in an item placement area. The image 5 is an image captured by the sensor device 100. The subjects of the image 5 include the customer 30, the store shelf 31, and the item 32. The store shelf 31 is installed in the front of the sensor device 100. The customer 30 is located at the far end of the store shelf 31 seen from the sensor device 100.

An area 31a is the set area corresponding to the item placement area in which a predetermined item (here, the item 32) is placed on the store shelf 31, and is arbitrarily set in the image by the user. It is assumed that, in the state before the customer 30 appears in front of the store shelf 31, the item 32 had been placed in the item placement area corresponding to the area 31a, as illustrated by the dotted line in FIG. 7.

In addition, the exhibition management apparatus 200 has the image of the item 32 preliminarily stored in the storage device (such as HDD 203) provided in the exhibition management apparatus 200.

Here, it is assumed that the exhibition management apparatus 200 has received data of the image 5 from the sensor device 100. On this occasion, no image matching the preliminarily stored image of the item 32 exists in the area 31a in the image 5. Therefore, the exhibition management apparatus 200 determines that the item 32 does not exist in the item placement area corresponding to the area 31a.

FIG. 8 illustrates an exemplary determination of whether the position of the item has been moved from the proper position in the item placement area. In FIG. 8, description of the same elements as those in FIG. 7 will be omitted.

The image 6 is an image of the same area as that in the image 5 captured by the sensor device 100 before starting monitoring the situation of the item. In the image 6, the area 31a is the set area which has been set to a similar position or range to the image 5, and corresponds to the item 32. Additionally, in the image 6, the item 32 is photographed in a state placed at the proper position in the corresponding item placement area.

The image 7 is an image captured by the sensor device 100. The area in which the image 7 has been captured is identical to the area in which the image 5 and the image 6 have been captured. The state of the item placement area appearing in the image 7 is such that the customer 30 has taken the item 32 in hand and subsequently returned the item 32 to the item placement area so that the item 32 has been moved from the proper position in the item placement area.

Here, let us assume that the exhibition management apparatus 200 has received data of the image 6 from the sensor device 100 before starting monitoring the situation of the item. On this occasion, the exhibition management apparatus 200 acquires an area 31b appearing in the image in which the item 32 is placed, and stores the acquired area 31b as an image area of the properly placed item 32 in the storage device (such as HDD 203) provided in the exhibition management apparatus 200.

Next, let us assume that data of the image 7 has been received from the sensor device 100. On this occasion, when the image area of the item 32 and the area 31b in the image 7 do not match, the exhibition management apparatus 200 determines that the position of the item 32 in the item placement area corresponding to the area 31a has been moved from the proper position.

The area 31b in the image 6 may be set outside the external form of the item 32 in the image 6, as illustrated in FIG. 8. In this case, the exhibition management apparatus 200 determines that the item 32 has been moved from the proper position when at least a part of the area in the image 7 in which the item 32 appears is not included in the area 31b. Accordingly, when the customer 30 has taken the item 32 in hand and subsequently returned it, for example, it is not determined that the item 32 has been moved as long as the amount of movement of the item 32 need not be re-exhibited. Therefore, outputting an alarm is prevented when the amount of movement of the item 32 need not be re-exhibited.

In addition, determining whether or not an item has been moved is not limited to the method described referring to FIGS. 7 and 8. For example, the determining is possible by analyzing the received image to extract a position indicating the characteristics included in the shape of an item in an image, and comparing the extracted representative position and the position at which the item is placed. In addition, whether or not the position of an item has been moved may be determined by whether it is possible to read information of an IC tag attached to each item by a non-contact IC reader installed in each item placement area.

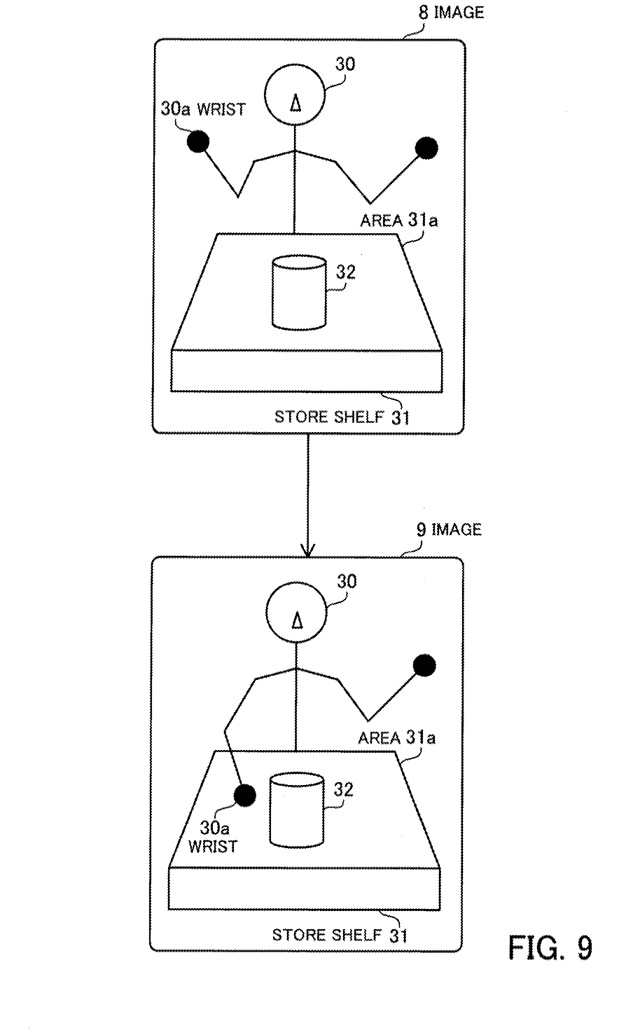

Next, a method of determining whether a customer has reached out his/her hand to an item will be described, referring to FIG. 9. The exhibition management apparatus 200 determines that a customer has reached out his/her hand to an item when the position of the customer's wrist appearing in an image is within the range of the set area corresponding to the item placement area.

FIG. 9 illustrates an exemplary determination of whether a customer has reached out his/her hand to an item. The image 8 is an image of the same area as that in the image 7 captured by the sensor device 100. The subjects of the image 8 include the customer 30, the store shelf 31, and the item 32, similarly to the image 7. In the following, description of elements in the image 8 similar to those in the image 7 will be omitted.

In the image 8, the customer 30 is located at the far end of the store shelf 31 seen from the sensor device 100. In the image 8, the position of a wrist 30a of the customer 30 is not included in the area 31a.

Here, let us assume that the exhibition management apparatus 200 has received data of the image 8 from the sensor device 100. On this occasion, the position of the wrist 30a is not included in the area 31a and therefore the exhibition management apparatus 200 determines that the customer 30 has not reached out his/her hand to the item 32.

The image 9 is an image of the same area as that in the image 7 captured by the sensor device 100. In the following, description of elements in the image 9 similar to those in the image 7 will be omitted. In the image 9, the position of the wrist 30a is included in the area 31a.

Here, let us assume that the exhibition management apparatus 200 has received data of the image 9 from the sensor device 100. On this occasion, the position of the wrist 30a is included in the area 31a and therefore the exhibition management apparatus 200 determines that the customer 30 has reached out his/her hand to the item 32.

Determining whether a customer has reached out his/her hand to an item is not limited to the method described in FIG. 9, and whether or not an item has been moved may be determined, for example, by whether information of an IC tag attached to each item is readable by a non-contact IC reader held by each customer.

In addition, although a single item placement area is set on a single store shelf in the exhibition management system 3, a plurality of item placement areas may be set on a single store shelf. In addition, there may be a plurality of item placement areas corresponding to a single item (e.g., item 32).

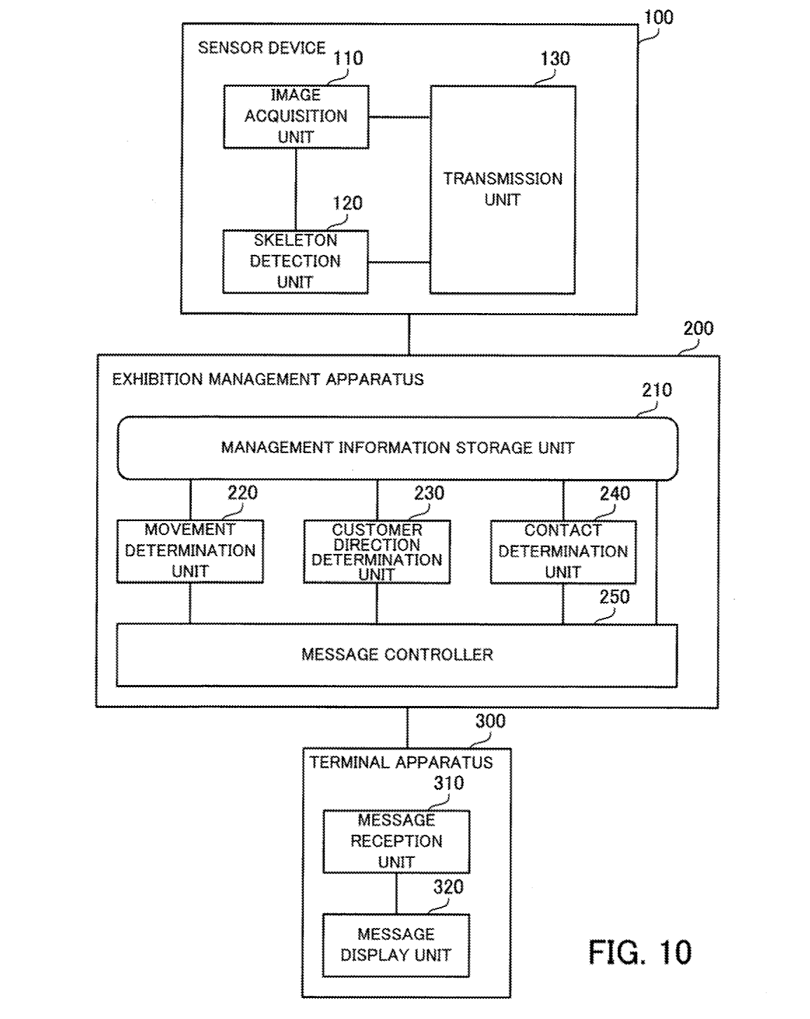

FIG. 10 illustrates exemplary functions of the sensor device, the exhibition management apparatus, and the terminal apparatus. The sensor device 100 has an image acquisition unit 110, a skeleton detection unit 120, and a transmission unit 130.

The image acquisition unit 110 acquires data of images captured by the imaging camera 104 at a predetermined time interval (e.g., every 1/30 seconds).

The skeleton detection unit 120 detects the position of a predetermined region of the skeleton such as the wrist of a person appearing in the image, based on the image data and depth information according to the depth sensor 105. The skeleton detection unit 120 detects the position of the region of the skeleton each time the image acquisition unit 110 acquires image data, and generates skeletal information including the position information of each part of the skeleton. The position information of each region of the skeleton includes information indicating the coordinates on an image of each region of a customer appearing in the image, and information indicating the depth of each region of the skeleton. The “depth of a region (e.g., wrist) of the skeleton” refers to the depth of pixels corresponding to each region of the skeleton.

The transmission unit 130 transmits, to the exhibition management apparatus 200, data of a captured image and skeletal information of a customer appearing in the image. The data of the captured image includes a device ID (identification) for identifying the sensor device.

Each processing by the image acquisition unit 110, the skeleton detection unit 120 and the transmission unit 130 is implemented, for example, by executing a predetermined program by the processor 101.

The exhibition management apparatus 200 has a management information storage unit 210, a movement determination unit 220, a customer direction determination unit 230, a contact determination unit 240, and a message controller 250.

The management information storage unit 210 has image data of an item preliminarily stored therein. The image of an item is used when determining whether or not the item has been moved. In the following, a preliminarily stored image of an item may be referred to as an “item image”.

In addition, the management information storage unit 210 stores an area information table having preliminarily stored therein information relating to a set area corresponding to an item placement area. In addition, the management information storage unit 210 stores an item information table for storing information relating to items sold in a store, and a message information table for storing information for generating messages relating to the situation of an item. Furthermore, the management information storage unit 210 stores an item situation setting table for temporarily storing information relating to the situation of an item. The management information storage unit 210 is implemented, for example, as a nonvolatile storage area secured in the HDD 203 or the like.

The movement determination unit 220 receives, from the sensor device 100, image data and skeletal information of a customer appearing in the image. The movement determination unit 220 detects that a customer has appeared in the vicinity of an item placement area, based on the received skeletal information. The movement determination unit 220 creates a record corresponding to the detected customer in the item situation setting table.

In addition, the movement determination unit 220 analyzes an image received before starting monitoring the situation of an item to acquire an image area of the item when being placed at the proper position, and registers information indicating the acquired image area in the area information table. Upon starting monitoring the situation of an item, the movement determination unit 220 determines whether an item on an item placement area has been moved, based on the information of the captured image, the item image preliminarily stored in the management information storage unit 210, and the information indicating the image area stored in the area information table.

The customer direction determination unit 230 determines the direction of the customer, based on the positions or the like of one or more regions (e.g., shoulders) in the skeleton of the customer. The customer direction determination unit 230 then determines whether the customer is facing the direction of the item placement area corresponding to the set area, referring to the area information table.

The contact determination unit 240 determines whether the customer has reached out his/her hand to an item, based on the positional relation between the position of the customer's wrist in the image and the set area corresponding to the item placement area. The position of the customer's wrist is determined based on the received skeletal information. The range of the set area is determined based on the area information table.

The message controller 250 determines the situation of an item, based on respective determination results of whether an item on an item placement area has been moved, the direction of the customer, and whether the customer has reached out his/her hand to the item, and also on the information stored in each table stored in the management information storage unit 210. When determining the situation of an item, the message controller 250 uses the item situation setting table. Whether an item on an item placement area has been moved is determined by the movement determination unit 220, the direction of a customer is determined by the customer direction determination unit 230, and whether a customer has reached out his/her hand to the item is determined by the contact determination unit 240. The message controller 250 generates a message relating to the situation of the item. The message controller 250 transmits the generated message to the terminal apparatus 300.

Each processing by the movement determination unit 220, the customer direction determination unit 230, the contact determination unit 240, and the message controller 250 is implemented, for example, by executing a predetermined program by the processor 201.

The terminal apparatus 300 has a message reception unit 310 and a message display unit 320. The message reception unit 310 receives messages relating to the situation of an item from the exhibition management apparatus 200. The message display unit 320 displays the received message on the display 304. Each processing by the message reception unit 310 and the message display unit 320 is implemented, for example, by executing a predetermined program by the processor 301.

Although, in the exhibition management system 3, the terminal apparatus 300 displays the message generated by the exhibition management apparatus 200, the terminal apparatus 300 may generate and display a message in the following manner. First, the exhibition management apparatus 200 transmits, to the terminal apparatus 300, information indicating the result of determination by the movement determination unit 220, the contact determination unit 240, and the customer direction determination unit 230, together with the identifier of the item whose exhibition is disordered. Next, the terminal apparatus 300 generates a message based on the received information and displays the message on the display 304. In this case, the item information table and the message information table are preliminarily stored in the terminal apparatus 300, instead of the exhibition management apparatus 200.

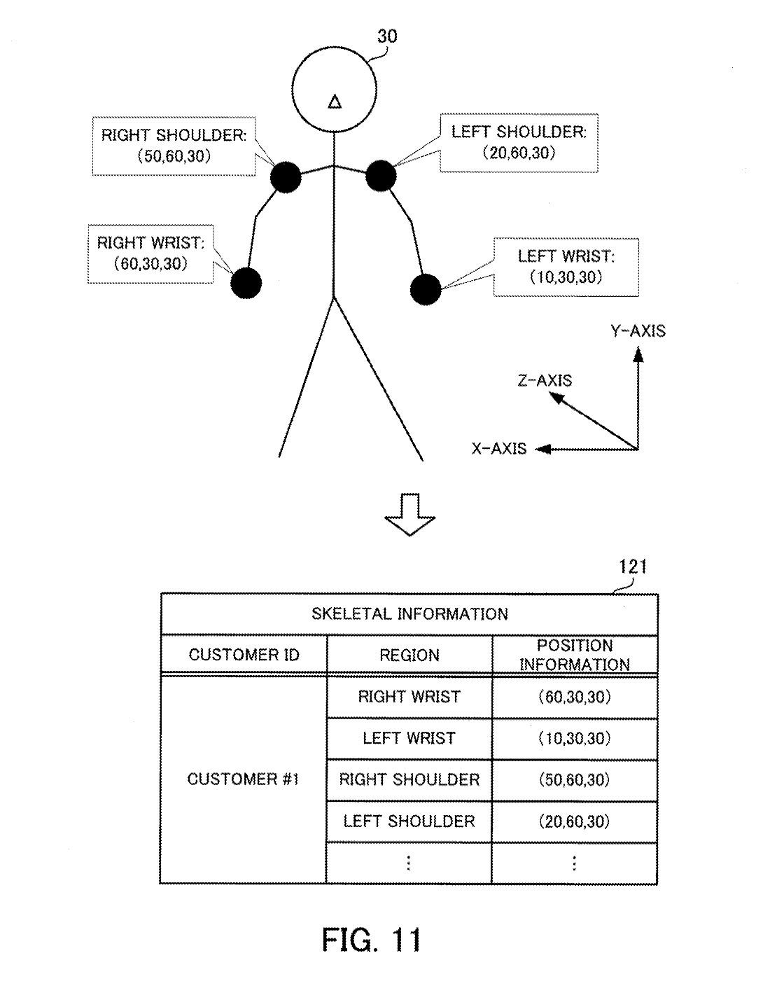

Next, data and tables used in the exhibition management system 3 will be described, referring to FIGS. 11 to 14.

FIG. 11 illustrates an example of skeletal information. Skeletal information 121 is information indicating the position of each region of the skeleton such as customer's head and joints of wrist. The skeletal information 121 is generated by the skeleton detection unit 120. The skeletal information 121 has columns for a customer ID, a region, and position information.

A customer ID column has set therein an identifier for identifying a customer appearing in an image. A region column has set therein information indicating the type of a region of the skeleton.

A position information column has set therein position information of a region. In the exhibition management system 3, the position information is represented as “(position in X-axis direction, position in Y-axis direction, and position in Z-axis direction)”. The X-axis is an axis in the horizontal direction perpendicular to the optical axis of the imaging camera 104, taking the positive sign in the leftward direction seen from the imaging camera 104. The Y-axis is an axis in the vertical direction perpendicular to the optical axis of the imaging camera 104, taking the positive sign in the upward direction seen from the imaging camera 104. The Z-axis is an axis in the direction of the optical axis of the imaging camera 104, taking the positive sign in the direction the imaging camera 104 is facing. In other words, coordinates of the X- and Y-axes indicate the position of the region of the skeleton in an image, whereas coordinates of the Z-axis indicate the depth of the region of the skeleton.

For example, as illustrated in FIG. 11, the right wrist, left wrist, right shoulder, and left shoulder are detected as regions of the skeleton. Assuming that the coordinate of the right wrist of the customer 30 in the image is “(60,30)” and the depth is “30”, “(60,30,30)” is set to the position information column corresponding to the “right wrist” of the customer 30 in the skeletal information 121.

In addition to the aforementioned representation, the position information of regions of the skeleton may be represented in another way such as using latitude, longitude, and height.

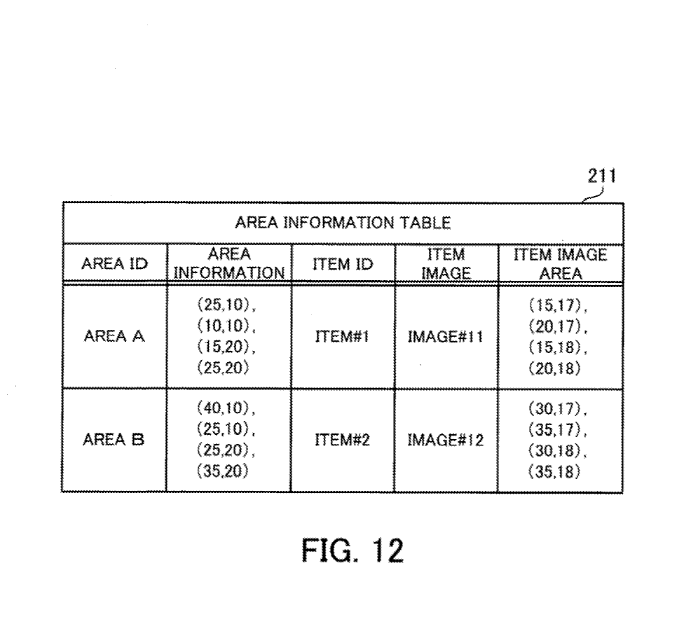

FIG. 12 illustrates an exemplary area information table. The area information table 211 has information relating to a set area preliminarily stored therein. The area information table 211 is stored in the management information storage unit 210. The area information table 211 has columns for an area ID, area information, an item ID, an item image, and an item image area.

An area ID column has set therein an identifier for identifying a set area.

An area information column has set therein information indicating a set area. Let us assume that, in the exhibition management system 3, the set area is a quadrangle. In addition, the information indicating the set area is represented by coordinates of the four corners of the area in which items are placed. Coordinates of the four corners are represented by “(position in X-axis direction, and position in Y-axis direction)”. The set area is not limited to a quadrangle and may be round or circular. In addition, when the set area is a rectangle, the information indicating the set area may be represented by only the top-right and bottom-left coordinates, for example.

An item ID column has set therein an identifier for identify an item to be placed in an item placement area corresponding to a set area. The same item ID may be set in the item ID column corresponding to the different area ID.

An item image column has set therein information indicating an item image corresponding to an item. The information indicating an item image may be data of an item image, or may be information indicating a storage destination of the data of an item image.

An item image area column has set therein information indicating an image area of an item when the item is placed at the proper position in the item placement area corresponding to the set area. When, in the exhibition management system 3, the image area of an item in the captured image does not match the item image area, it is determined that the item has been moved from the proper position. When at least a part of the image area of the item in the captured image is not included in the item image area, it may be determined that the item has been moved from the proper position.

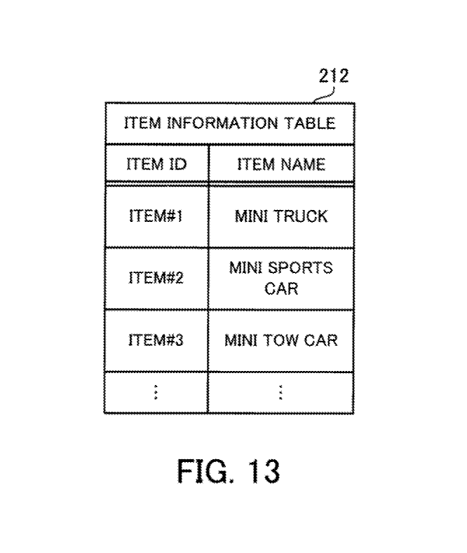

FIG. 13 illustrates an exemplary item information table. The item information table 212 has preliminarily stored therein information relating to an item sold in the store. The item information table 212 is stored in the management information storage unit 210.

The item information table 212 has columns for item ID and item name. An item ID column has set therein an identifier for identifying an item sold in the store. An item name column has set therein a character string indicating an item name as information to be displayed on the terminal apparatus 300.

The item information table 212 may include, besides the aforementioned columns, information indicating the price of an item, or information indicating the image of an item.

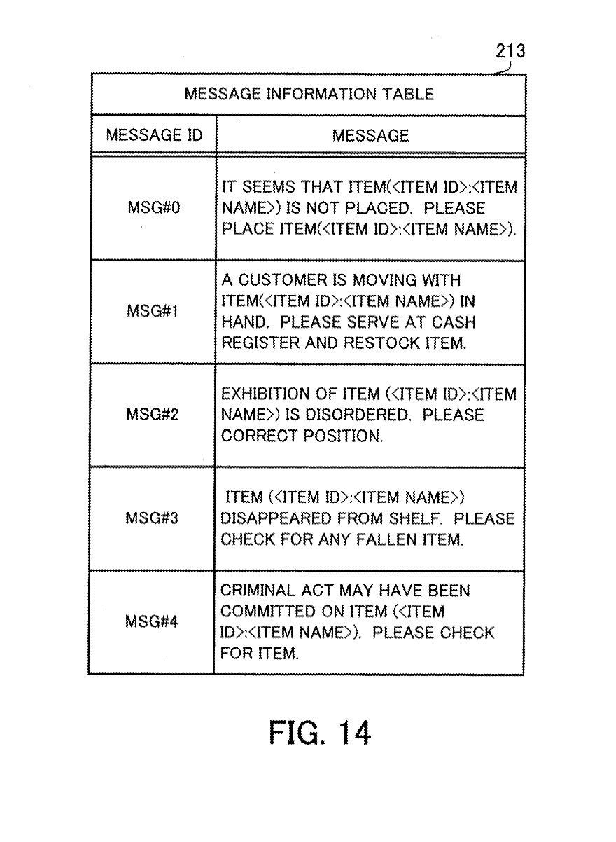

FIG. 14 illustrates an exemplary message information table. The message information table 213 has preliminarily stored therein information relating to the situation of an item. The message information table 213 is stored in the management information storage unit 210.

The message information table 213 has columns for message ID and message. A message ID column has set therein an identifier for identifying a message relating to the situation of an item. A message column has set therein a character string indicating a message to be displayed on the terminal apparatus 300. An “<item ID>” in the character string has set therein an item ID of the item of interest (moved) when the exhibition management apparatus 200 generates a message. In addition, an “<item name>” in the character string has set therein an item name of the item of interest (moved) when the exhibition management apparatus 200 generates a message.

A message with the message ID “MSG#0” corresponds to a situation in which the item placement area has been photographed in a state without an item placed therein, before the exhibition management apparatus 200 starts monitoring the situation of the item. In other words, a message with the message ID “MSG#0” corresponds to a situation in which monitoring an item is attempted in a state without the item being placed in the item placement area.

A message with the message ID “MSG#1” corresponds to a situation in which a customer has moved, taking an item in hand with the purpose of purchasing the same, and thus the item no longer exists in the item placement area.

A message with the message ID “MSG#2” corresponds to a situation in which exhibition of an item is disordered such that, when a customer left the vicinity of the item placement area, an item in the item placement area has been moved from the proper position.

A message with the message ID “MSG#3” corresponds to a situation in which a baggage held by a customer, or a part of the customer's body other than the hand contacted an item, causing the item to drop from the store shelf, and thus the item has disappeared from the item placement area.

A message with the message ID “MSG#4” corresponds to a situation in which a customer has committed a criminal act on an item such as shoplifting, and thus the item has disappeared from the item placement area.

While a message with one of the message IDs “MSG#1” to “MSG#4” indicates the situation of an item, a message with the message ID “MSG#0” indicates that it is impossible to normally monitor the situation of an item, and accordingly the messages are of different natures.

In addition, the message illustrated in FIG. 14 is an example of the warning information 2c of the first embodiment.

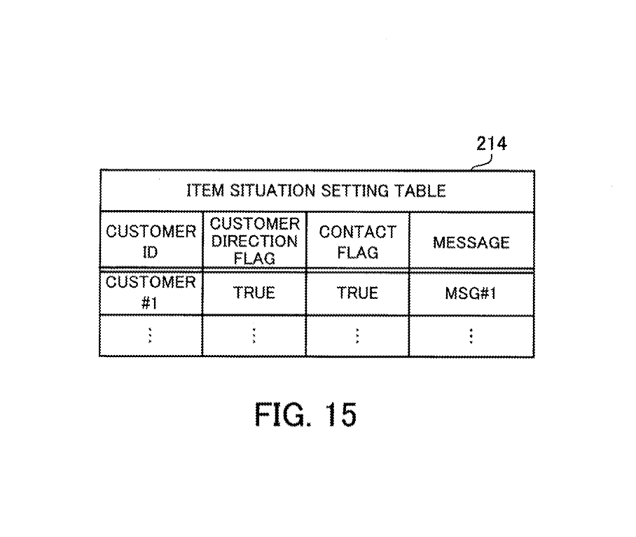

FIG. 15 illustrates an exemplary item situation setting table. The item situation setting table 214 has temporarily stored therein information relating to the situation of an item. The item situation setting table 214 is stored in the management information storage unit 210. The item situation setting table 214 has columns for customer ID, customer direction flag, contact flag, and message ID.

A customer ID column has set therein an identifier for identifying a customer appearing in an image. A customer direction flag column has set therein information indicating whether a state has been detected in which a customer has faced the direction of the item placement area during the period from when the customer's skeleton is detected (the customer appears in the vicinity of the item placement area) to when the customer's skeleton is no longer detected (the customer left the vicinity of the item placement area). For example, the customer direction flag column is set to “TRUE” when a state has been detected, at least once, in which the customer's body had faced the direction of the item placement area during the period from when the customer appeared in the vicinity of the item placement area to when the customer left there, with the initial value of the identifier having been set to “FALSE”. On the other hand, the customer direction flag column remains to be “FALSE” when a state has never been detected in which the customer's body had faced the direction of the item placement area during the period from when the customer appeared in the vicinity of the item placement area to when the customer left there.

The contact flag column has set therein information indicating whether a state has been detected in which a customer has reached out his/her hand to an item during the period from when a customer appeared in the vicinity of the item placement area to when the customer left there. For example, the contact flag column is set to “TRUE” when a state has been detected, at least once, in which the customer had reached out his/her hand to an item during the period from when a customer appeared in the vicinity of the item placement area to when the customer left there, with the initial value of the information having been set to “FALSE”. On the other hand, the contact flag column remains to be “FALSE” when a state has never been detected in which the customer had reached out his/her hand to an item during the period from when a customer appeared in the vicinity of the item placement area to when the customer left there.

The message ID column has set therein an identifier for identifying, for an item placed in the item placement area to which a customer has moved, a message relating to the situation of the item. The column is used, for example, when creating history information relating to the situation of the item.

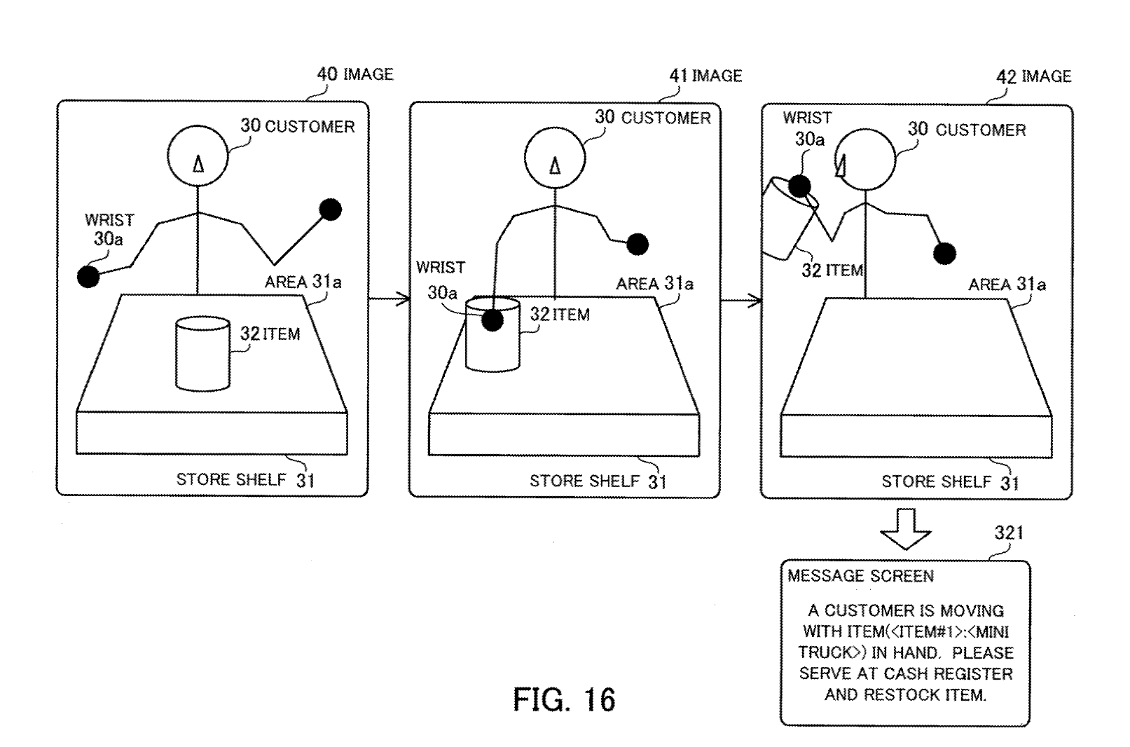

Next, an exemplary display of a message according to the situation of an item will be described, referring to FIGS. 16 to 19. In FIGS. 16 to 19, an exemplary display of a message relating to the situation of an item whose item ID is “item#1” and item name is “mini truck”. In addition, for the images described in FIGS. 16 to 19, description of elements similar to those in the image 5 may be omitted.

FIG. 16 illustrates an exemplary display of a first message. A message screen 321 is a screen for displaying a message relating to the situation of an item. The message screen 321 is displayed on the display 304 provided in the terminal apparatus 300.

The image 40 is an image captured by the sensor device 100. In the image 40, the customer 30 is facing the direction of the item placement area corresponding to the item 32. Additionally, in the image 40, the position of the wrist 30a, which is a right wrist of the customer 30, is not included in the area 31a. In other words, the hand of the customer 30 appearing in the image 40 has not reached the item 32.

The image 41 is an image captured by the sensor device 100 after the image 40 has been captured. Additionally, in the image 41, the position of the wrist 30a is included in the area 31a. In other words, the hand of the customer 30 appearing in the image 41 has reached the item 32. Additionally, in the image 41, the customer 30 is facing the direction of the item placement area corresponding to the item 32.

The image 42 is an image captured by the sensor device 100 after the image 41 has been captured. In the image 42, the customer 30 is about to leave the item placement area with the item 32 taken in hand.

Here, let us assume that the exhibition management apparatus 200 starts receiving the skeletal information of the customer 30 (i.e., receives the skeletal information of the customer 30 for the first time), and subsequently receives the image data in the order of images 40, 41 and 42. On this occasion, the exhibition management apparatus 200 first detects, by receiving the skeletal information of the customer 30 corresponding to an image (not illustrated) which had been received before the image 40, that the customer 30 has appeared in the vicinity of the item placement area.

Next, the exhibition management apparatus 200 determines, by analyzing the image 40, that the customer 30 is facing the direction of the item placement area corresponding to the area 31a. In addition, the exhibition management apparatus 200 determines, by analyzing the image 41 received after the image 40, that the wrist 30a of the customer 30 is included in the item placement area corresponding to the area 31a. In other words, the exhibition management apparatus 200 determines that the hand of the customer 30 has reached the item 32.

Subsequently, the customer 30 moves as indicated in the image 42, and also the position of the skeleton of the customer 30 moves along with the movement. On this occasion, let us assume that the item 32 does not exist in the item placement area corresponding to the area 31a. The skeletal information of the customer 30 is no longer detected from subsequently received images (not illustrated). In other words, the customer 30 no longer appears in images received from the sensor device 100. Let us assume that the item 32 is still missing from the item placement area corresponding to the area 31a, also at this time point.

When the aforementioned course is taken, the exhibition management apparatus 200 determines that the customer has moved, taking an item in hand with the purpose of purchasing the same, and thus the item has disappeared from the item placement area. Therefore, a message corresponding to the message ID “MSG#1” illustrated in FIG. 14 is generated by the exhibition management device 200. Specifically, a record including “MSG#1” is first retrieved from the message information table 213 by the exhibition management apparatus 200. Next, a message relating to the situation of the item is generated with “item#1” set to the part “<item ID>” and “mini truck” set to the part “<item name>” of the message of the retrieved record.

The generated message is transmitted to the terminal apparatus 300 by the exhibition management apparatus 200. As illustrated in the right bottom FIG. 16, the message screen 321 including the received message is displayed on the display 304 by the terminal apparatus 300 which has received the message.

When a customer, facing the direction of an item, has moved with the item in hand, it is conceivable that the customer has moved with the item in hand for a legitimate purpose. Therefore, as described in FIG. 16, the skeletal information is first detected (the customer 30 appears in the vicinity of the item placement area). Next, a state is detected in which the customer is facing the direction of the item placement area, and a state is detected in which the customer has reached out his/her hand to the item. Subsequently, when the item does not exist in the item placement area with the skeletal information being no longer detected (the customer 30 left the vicinity of the item placement area), the exhibition management apparatus 200 determines that the customer has moved, taking the item in hand with the purpose of purchasing the same. A message notifying the situation is then displayed on the display 304 of the terminal apparatus 300. Accordingly, even when a sales clerk is too busy to keep an eye on customers and the store shelf, the sales clerk is able to predict that a customer may move to the cash register, and take an action as appropriate, and also recognize that the item needs to be restocked.

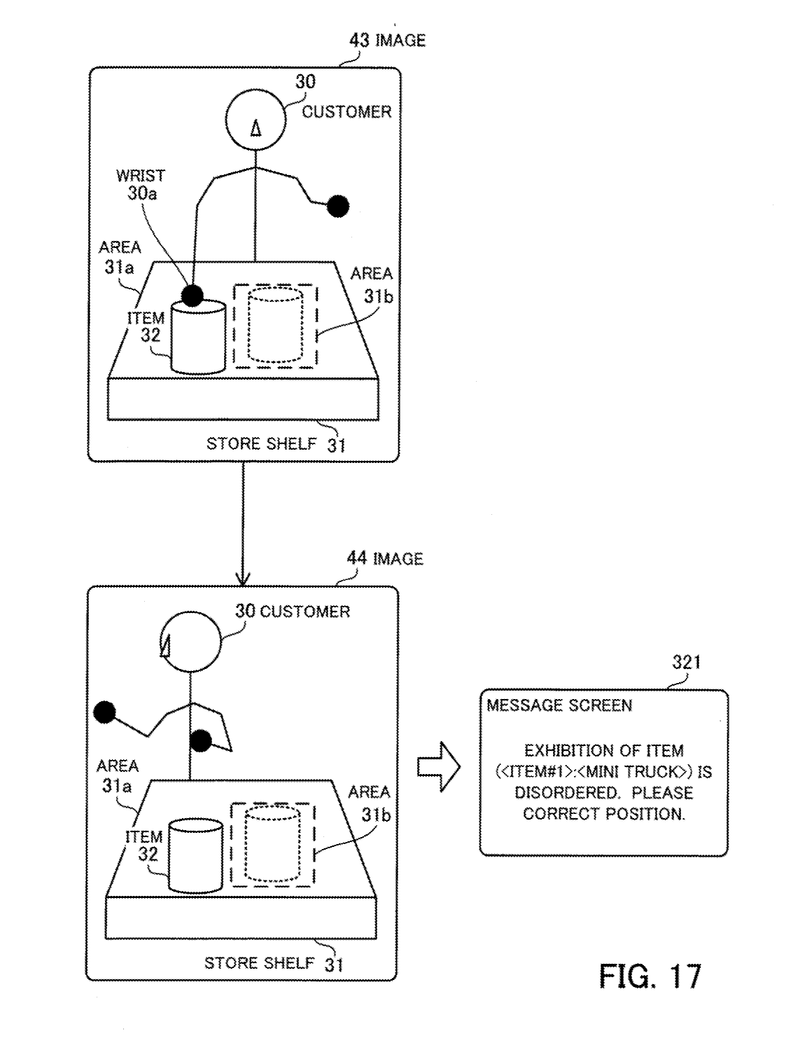

FIG. 17 illustrates an exemplary display of a second message. An image 43 is an image captured by the sensor device 100. In the image 43, the body of the customer 30 is facing the direction of the sensor device 100. In other words, the body of the customer 30 is facing the direction of the item placement area corresponding to the area 31a. Additionally, in the image 43, the customer 30 has taken the item 32 in hand and subsequently returned it to the item placement area. On this occasion, the item 32 has been moved from the proper position in the item placement area. The area 31b indicates the placement area of the item 32 when being placed at the proper position.

An image 44 is an image captured by the sensor device 100 after the image 43 has been captured. In the image 44, the customer 30 is about to leave the vicinity of the item placement area corresponding to the area 31a without taking the item 32 in hand.

Here, let us assume that the exhibition management apparatus 200 starts receiving the skeletal information of the customer 30 (i.e., receives the skeletal information of the customer 30 for the first time), and subsequently receives the image data in the order of images 43 and 44. On this occasion, the exhibition management apparatus 200 first detects, by receiving the skeletal information of the customer 30 corresponding to an image (not illustrated) which had been received before the image 43, that the customer 30 has appeared in the vicinity of the item placement area.

In the image 43 subsequently received, the item 32 is returned into the item placement area by the customer 30, and thus the item 32 has been moved from the proper position in the item placement area. In addition, subsequently, the customer 30 moves as illustrated in the image 44, and the position of the skeleton of the customer also moves along with the movement. The skeletal information of the customer 30 is no longer detected from subsequently received images (not illustrated). At this time point too, the item 32 has been moved from the proper position in the item placement area, similarly to the image 43.

When the aforementioned course is taken, the exhibition management apparatus 200 determines that the item in the item placement area has been moved from the proper position and exhibition of the item is disordered. Therefore, a message corresponding to the message ID “MSG#2” is generated by the exhibition management device 200, according to a similar method to the method described in FIG. 16, and transmitted to the terminal apparatus 300. The message screen 321 including the received message is then displayed on the display 304 by the terminal apparatus 300, as illustrated at the right-hand side of FIG. 17.

There may be a case where an item in the item placement area has been moved from the proper position, when the customer has left the vicinity of the item placement area. As such an example, there is conceivable a case where a customer takes an item in the item placement area in hand and returns the item to the item placement area, and thus the item is moved from the proper position in the item placement area and, subsequently, the customer leaves the vicinity of the item placement area. Therefore, as has been described in FIG. 17, the skeletal information is first detected and subsequently, when the item has been moved from the proper position of the item placement area with the skeletal information being no longer detected, the exhibition management apparatus 200 determines that exhibition of the item is disordered. A message notifying the situation is displayed on the display 304 of the terminal apparatus 300. Accordingly, even when a sales clerk is too busy to keep an eye on customers and the store shelf, the sales clerk is able to recognize that exhibition of the item is disordered, and take an action of returning the item to the proper position.

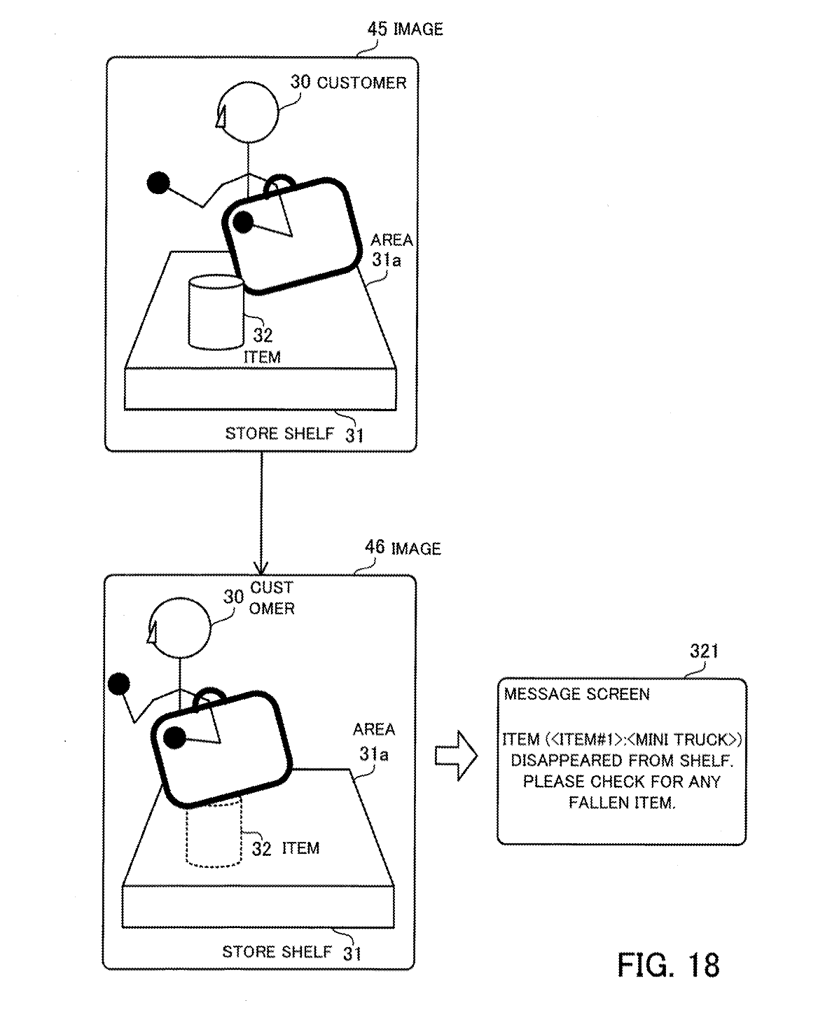

FIG. 18 illustrates an exemplary display of a third message. The image 45 is an image captured by the sensor device 100. In the image 45, the customer 30 is facing a direction (toward the left side, seen from the sensor device 100) other than the item placement area corresponding to the item 32. Additionally, in the image 45, the position of each wrist of the customer 30 is not included in the area 31a. In other words, the hand of the customer 30 appearing in the image 45 has not reached the item 32.

The image 46 is an image captured by the sensor device 100 after the image 45 has been captured. In the image 46, the customer 30 is facing a direction (toward the left side, seen from the sensor device 100) other than the item placement area corresponding to the item 32, similarly to the image 45, and the hand of the customer 30 has not reached the item 32. Furthermore, the item 32 has fallen from the store shelf 31 due to being contacted by the baggage held by the customer 30, and does not exist in the item placement area corresponding to the area 31a.

Here, let us assume that the exhibition management apparatus 200 starts receiving the skeletal information of the customer 30 (i.e., receives the skeletal information of the customer 30 for the first time), and subsequently receives the image data in the order of images 45 and 46. On this occasion, the exhibition management apparatus 200 first detects, by receiving the skeletal information of the customer 30 corresponding to an image (not illustrated) which had been received before the image 45, that the customer 30 has appeared in the vicinity of the item placement area.

Next, the exhibition management apparatus 200 determines, by analyzing the image 45, that the wrist 30a of the customer 30 is not included in the item placement area corresponding to the area 31a. In other words, the exhibition management apparatus 200 determines that the hand of the customer 30 has not reached the item 32. In addition, the exhibition management apparatus 200 determines, by analyzing the image 45, that the customer 30 is facing a direction other than the item placement area corresponding to the area 31a.

Next, the exhibition management apparatus 200 determines, by analyzing the image 46, that the item 32 no longer exists in the item placement area corresponding to the area 31a. In addition, the exhibition management apparatus 200 determines that the customer 30 had been facing a direction other than the item placement area corresponding to the area 31a until the image 46 was received, and the hand of the customer 30 has not reached the item 32.

When the aforementioned course is taken, the exhibition management apparatus 200 determines that the item 32 has fallen from the store shelf 31 due to being contacted by a baggage of the customer 30 or a part of the body of the customer 30 other than the hand, and does not exist in the item placement area. Therefore, a message corresponding to the message ID “MSG#3” is generated by the exhibition management apparatus 200 and transmitted to the terminal apparatus 300, according to a method similar to the method described in FIG. 16. Subsequently, the message screen 321 including the received message is displayed on the display 304 by the terminal apparatus 300, as illustrated in right-hand side of FIG. 18.

When the customer's baggage or a part of the customer's body other than the hand unintentionally contacts an item, the customer's hand does not reach the item, with the customer facing a direction other than the item placement area in which the item is placed. In addition, when fallen from the store shelf, the item does not exist in the item placement area. Therefore, when neither a state in which the customer's hand has reached the item, nor a state in which the customer is facing the direction of the item placement area has been detected, during a period from when the skeletal information of the customer is detected to when the image captured when the item disappeared from the item placement area is received, as described in FIG. 18, the exhibition management apparatus 200 determines that an item has fallen from the store shelf due to contact with the customer's baggage or a part of the body of the customer 30 other than the hand.

Such a situation occurs by a customer passing by the vicinity of an item without stopping and is not able to be detected by the sales clerk unless always monitoring the behavior of the customer. The exhibition management apparatus 200 allows the sales clerk to recognize that such a situation has occurred without having to keep an eye on the customer, and take an action such as returning the item to its original position, for example.

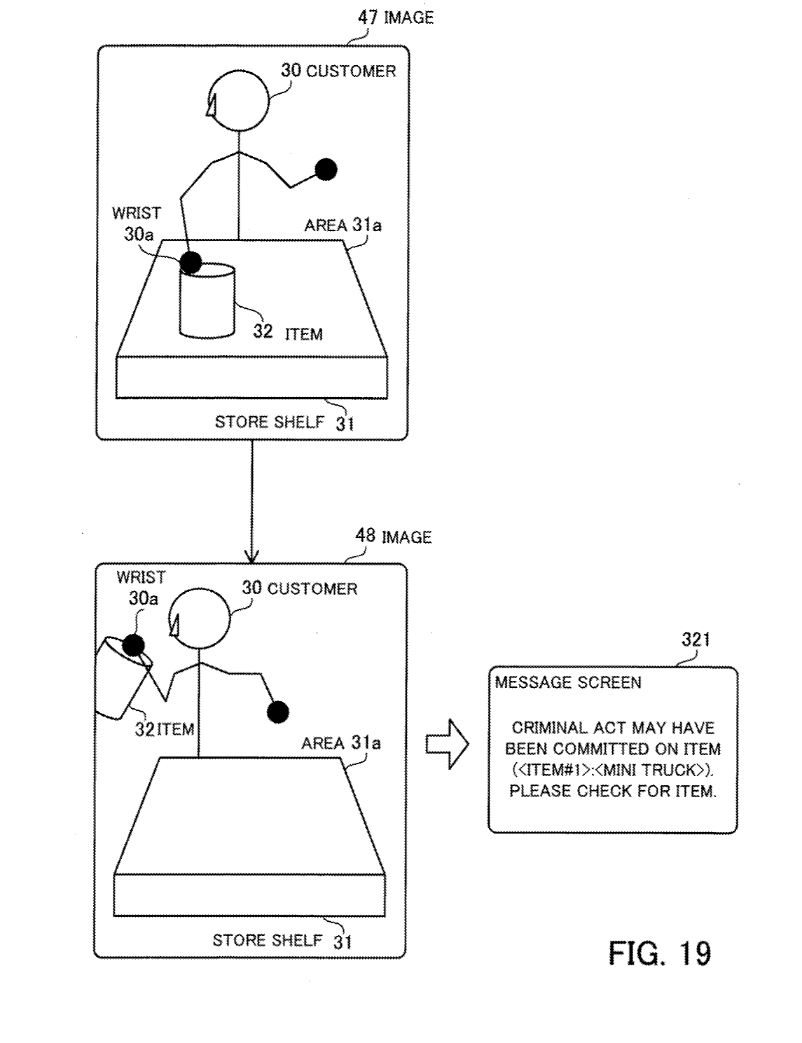

FIG. 19 illustrates an exemplary display of a fourth message. An image 47 is an image captured by the sensor device 100. In the image 47, the customer 30 is facing a direction (toward the left side, seen from the sensor device 100) other than the item placement area corresponding to the item 32. Additionally, in the image 47, the position of the wrist 30a which is the right wrist of the customer 30 is included in the area 31a. In other words, the hand of the customer 30 appearing in the image 47 has reached the item 32.

An image 48 is an image captured by the sensor device 100 after the image 47 has been captured. Additionally, in the image 48, the customer 30 is facing a direction (toward the left side, seen from the sensor device 100) other than the item placement area corresponding to the item 32, and the hand of the customer 30 has not reached the item 32. Additionally, in the image 48, the item 32 has been taken away by the customer 30 and does not exist in the item placement area corresponding to the area 31a.

Here, let us assume that the exhibition management apparatus 200 starts receiving the skeletal information of the customer 30 (i.e., receives the skeletal information of the customer 30 for the first time), and subsequently receives the image data in the order of images 47 and 48. On this occasion, the exhibition management apparatus 200 first detects, by receiving the skeletal information of the customer 30 corresponding to an image (not illustrated) which had been received before the image 47, that the customer 30 has appeared in the vicinity of the item placement area.

Next, the exhibition management apparatus 200 determines, by analyzing the image 47, that the wrist 30a of the customer 30 is included in the item placement area corresponding to the area 31a. In other words, the exhibition management apparatus 200 determines that the hand of the customer 30 has reached the item 32. In addition, the exhibition management apparatus 200 determines, by analyzing the image 47, that the customer 30 is facing a direction other than the item placement area corresponding to the area 31a.

Next, the exhibition management apparatus 200 determines, by analyzing the image 48, that the item 32 no longer exists in the item placement area corresponding to the area 31a. In addition, the exhibition management apparatus 200 determines that the customer 30 had been facing a direction other than the item placement area corresponding to the area 31a until the image 48 was received.

When the aforementioned course is taken, the exhibition management apparatus 200 determines that an item in the item placement area has been taken away by a criminal act (e.g., shoplifting) committed on the item by a customer. Therefore, a message corresponding to the message ID “MSG#4” is generated by the exhibition management device 200, according to a method similar to the method described in FIG. 16, and transmitted to the terminal apparatus 300. Subsequently, the message screen 321 including the received message is displayed on the display 304 by the terminal apparatus 300, as illustrated in the right-hand side of FIG. 19.

Here, when a customer commits a criminal act on an item such as shoplifting, the customer's hand reaches an item. However, it is very likely that the customer passes without stopping, and therefore it is highly possible that the customer is not facing the direction of the item placement area in which the item is placed. Accordingly, let us assume that a state in which the customer's hand had reached the item has been detected, but a state in which the customer was facing the direction of the item placement area has been not detected, during a period from when the skeletal information of the customer was detected to when the image captured when the item disappeared from the item placement area was received, as described in FIG. 19. On this occasion, the exhibition management apparatus 200 determines that the item has been taken away by a criminal act by the customer.

As with the case of FIG. 18, the situation such as in FIG. 19 is not able to be detected by a sales clerk unless always monitoring the behavior of the customer. The exhibition management apparatus 200 allows the sales clerk to recognize that such a situation has occurred without having to keep an eye on the customer, and take an action such as checking the presence of the item or chasing the customer, for example.

As has been described in FIGS. 16 to 19, the exhibition management apparatus 200 determines the situation of an item, specifically how the item has been moved, and the cause of the movement, based on whether or not an item has been moved, whether a customer has reached out his/her hand to the item and the direction of the customer. Accordingly, the situation of an item may be accurately monitored by the sales clerk without having to always keep an eye on the customer.

In addition, a message according to the determined situation of the item is generated by the exhibition management apparatus 200 and transmitted to the terminal apparatus 300, and subsequently, the message screen 321 including the transmitted message is displayed on the display 304. Accordingly, a sales clerk holding the terminal apparatus 300 may grasp the situation of the item by referring to the displayed message and take an appropriate action according to the situation.

In the exhibition management system 3, the terminal apparatus 300 may sound an alarm according to the situation (message ID) of the item, in addition to displaying the message.

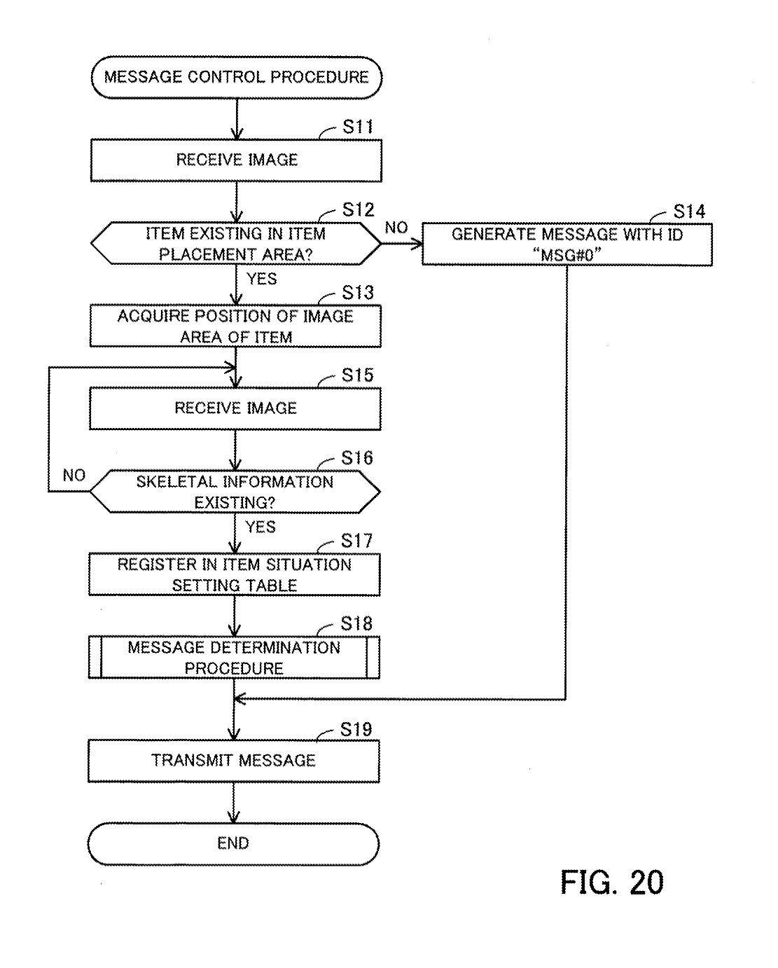

Next, a process of controlling messages relating to the situation of an item will be described using a flowchart, referring to FIGS. 20 to 23. In FIGS. 20 to 23, it is assumed that the number of customers appearing in a captured image is one. In addition, it is assumed in FIGS. 20 to 23 that there exists a single set area in a received image. It is conceivable that the procedures of FIGS. 20 to 23 start upon receiving a start instruction from an operator of a store to be processed, or upon being activated by a timer before the sale opening time. In addition, it is conceivable that the procedures of FIGS. 20 to 23 terminate upon receiving a termination instruction from the operator of the store to be processed, or by a timer after the sale closing time. The procedures of FIGS. 20 to 23 are repeatedly performed from activation until being terminated.

FIG. 20 is a flowchart illustrating an exemplary procedure of controlling output of a message. In the following, the process illustrated in FIG. 20 will be described along with step numbers.

(S11) The movement determination unit 220 receives image data captured by the sensor device 100 from the sensor device 100.

(S12) The movement determination unit 220 determines, by the method described referring to FIG. 7, whether an item exists in a corresponding item placement area. When the item does not exist in the item placement area, the process flow proceeds to step S14. When the item exists in the item placement area, the process flow proceeds to step S13. In the latter case, it is assumed that the item is placed at the proper position in the item placement area.

On this occasion, the set area corresponding to the item placement area may be acquired by retrieving a record including a corresponding area ID from the area information table 211, and reading area information of the retrieved record. In addition, the image of the item is acquired by reading an item image of the record retrieved from the area information table 211.

(S13) The movement determination unit 220 acquires the position of the image area of the item determined to be existing at step S12. The movement determination unit 220 registers the position information of the acquired image area in the item image area column of the record retrieved at step S12. The image area may be set to be larger than the external form of the item appearing in the image, such as the area 31b illustrated in FIG. 8.

As thus described, the exhibition management apparatus 200 acquires the position information of the item image area when the item is placed at the proper position in the item placement area by performing steps S11 to S13, before the exhibition management device 200 starts monitoring the situation of the item.

Subsequently, the exhibition management apparatus 200 monitors the situation of the item by performing the processes of steps S15 to S19.

(S14) The message controller 250 generates a message corresponding to the message ID “MSG#0” as follows. The message corresponds to a situation in which an image including an item placement area has been captured in a state that an item is not placed in the item placement area before starting monitoring the situation of the item.

First, the message controller 250 retrieves a record including a message with the message ID “MSG#0” from the message information table 213 and reads the message column of the retrieved record.

Next, the message controller 250 retrieves a record including an area ID corresponding to the set area from the area information table 211 and reads an item ID from the retrieved record. The message controller 250 then retrieves a record including the item ID from the item information table 212 and reads an item name from the retrieved record.

The message controller 250 then substitutes the “<item ID>” part of the read-out message with the read-out item ID, and substitutes the “<item name>” part of the read-out message with the read-out item name.

Subsequently, the process flow proceeds to step S19.

(S15) The movement determination unit 220 receives data of the image captured by the sensor device 100.

(S16) The movement determination unit 220 determines whether the skeletal information 121 has been received together with the image data at step S15. When the skeletal information 121 has been received, the process flow proceeds to step S17. When the skeletal information 121 has not been received, the process flow proceeds to step S15.

In other words, the movement determination unit 220 repeats the processes of steps S15 to S16 until the skeletal information 121 is received (until a customer appears in the vicinity of the item placement area).

(S17) The movement determination unit 220 creates a new record in the item situation setting table 214, sets, to the customer ID column, a customer ID included in the skeletal information 121 received at step S15, and sets “FALSE” to the customer direction flag column and the contact flag column.

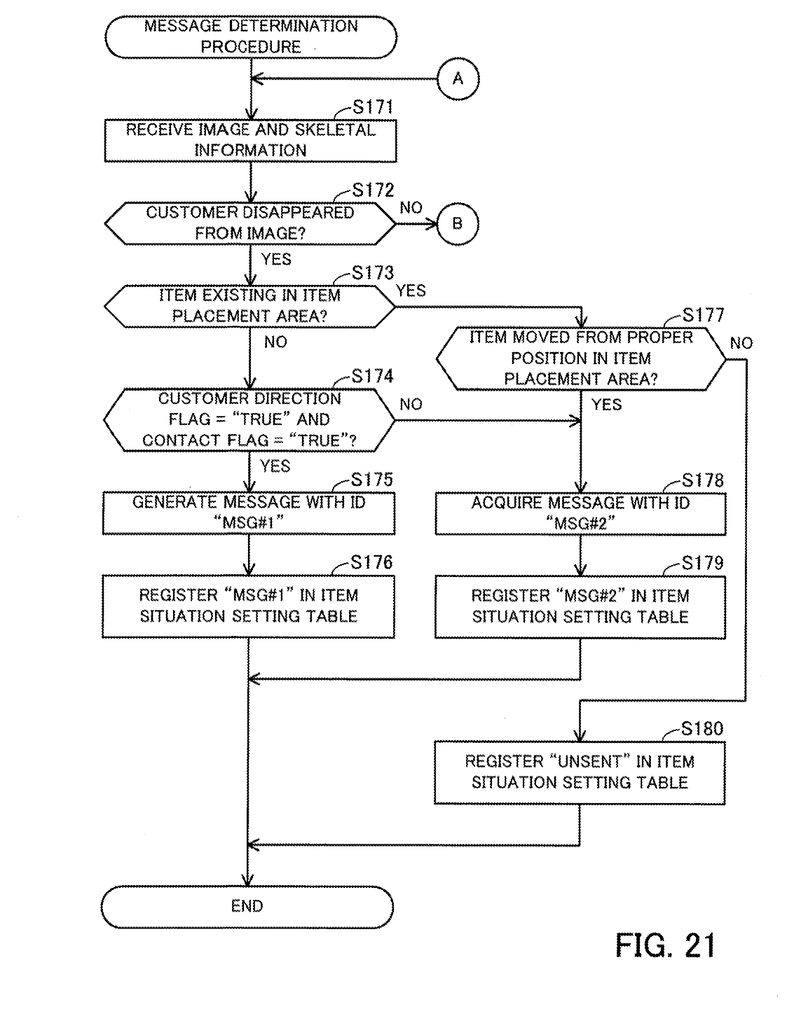

(S18) The exhibition management apparatus 200 receives data of the image captured by the sensor device 100 and the skeletal information 121 of the customer appearing in the image from the sensor device 100 at a predetermined time interval, and determines the contents of the message indicating the situation of the item, based on the image and the skeletal information 121 which have been received. Details will be described below, referring to FIGS. 21 to 23.

(S19) The message controller 250 transmits, to the terminal apparatus 300, the message generated by the processes in step S14 and step S17.

When there is a plurality of customers appearing in an image captured by the sensor device 100 (i.e., when information of a plurality of customers is included in the skeletal information 121 received from the sensor device 100), the processes of steps S17 to S19 are performed for each customer.

FIG. 21 is a flowchart illustrating an exemplary procedure of determining a message. The procedures of FIGS. 21 to 23 are performed at step S18 of FIG. 20. In the following, the processes illustrated in FIGS. 21 to 23 will be described along with step numbers.

(S171) The movement determination unit 220 receives data of the image captured by the sensor device 100 and the skeletal information 121 of the customer appearing in the image from the sensor device 100 at a predetermined time interval.

(S172) The movement determination unit 220 determines whether the customer in question has disappeared from the received image. Specifically, the movement determination unit 220 determines that the customer in question has disappeared, when the skeletal information 121 about the customer has not been received at step S171.

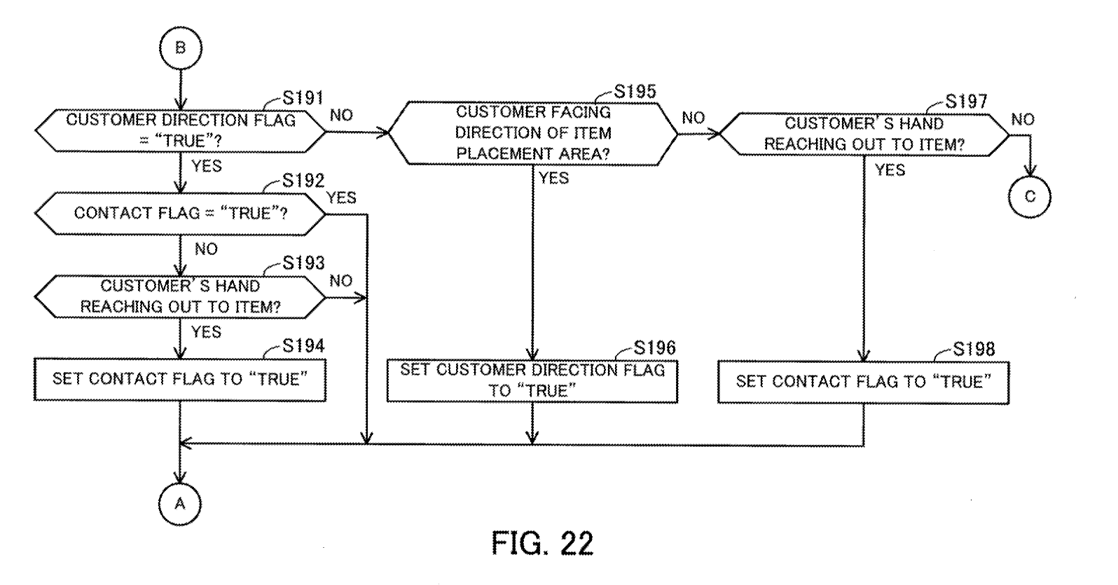

When the customer in question has disappeared from the image, the process flow proceeds to step S173. When the customer in question has not disappeared from the image, the process flow proceeds to step S191 of FIG. 22.

(S173) The movement determination unit 220 determines whether an item exists in a corresponding item placement area, in a manner similar to that in step S12 of FIG. 20. When the item does not exist in the item placement area, the process flow proceeds to step S174. When the item exists in the item placement area, the process flow proceeds to step S177.

(S174) The message controller 250 determines whether the customer direction flag corresponding to the customer determined at step S172 to have disappeared from the image (the customer who has left the vicinity of the item placement area) is “TRUE” and also the contact flag is “TRUE”. In other words, the message controller 250 determines whether a state in which the customer is facing the direction of the item placement area and a state in which the customer has reached out his/her hand to the item have already been detected from any of the images received during a period from when the process of step S171 is performed for the first time to when the current step is performed.

The customer direction flag and the contact flag may be acquired in the following manner. First, the customer ID of the customer who has disappeared from the image at step S172 is identified. Next, a record including the identified customer ID is retrieved from the item situation setting table 214. Subsequently, the customer direction flag and the contact flag are read from the retrieved record.

When both the customer direction flag and the contact flag are “TRUE”, the process flow proceeds to step S175. When at least one of the customer direction flag and the contact flag is “FALSE”, the process flow proceeds to step S178.

(S175) The message controller 250 generates a message corresponding to the message ID “MSG#1”, in a manner similar to that in step S14 of FIG. 20. The message corresponds to a situation of an item placement area when a customer moves with an item in hand with the purpose of purchasing the same.

(S176) The message controller 250 registers the message ID “MSG#1” in the item situation setting table 214 as follows.

First, the customer ID of the customer who disappeared from the image at step S172 is identified. Next, a record including the identified customer ID is retrieved from the item situation setting table 214. Subsequently, “MSG#1” is registered in the message ID column of the retrieved record.

(S177) The movement determination unit 220 determines, by the method described referring to FIG. 8, whether an item has been moved from the proper position in the item placement area. When the item has been moved from the proper position, the process flow proceeds to step S178. When the item remains at the proper position in the item placement area, the process flow proceeds to step S180.

On this occasion, the set area corresponding to the item placement area may be acquired by retrieving a record including a corresponding area ID from the area information table 211 and reading the area information of the retrieved record. In addition, the image of the item is acquired by reading the item image of the retrieved record. Furthermore, the proper position of the item may be acquired by reading the item image area of the retrieved record.

(S178) The message controller 250 generates a message corresponding to the message ID “MSG#2”, in a manner similar to that in step S14 of FIG. 20. The message corresponds to a situation in which exhibition of an item placed in the item placement area is disordered when a customer has left the vicinity of the item placement area. The situation in which exhibition of an item is disordered includes, for example, a case where an item in the item placement area has been moved from the proper position by an act of returning the item, which a customer took in hand, to the item placement area.

(S179) The message controller 250 registers the message ID “MSG#2” in the item situation setting table 214, in a manner similar to that in step S176.

(S180) The message controller 250 registers the message ID “unsent” in the item situation setting table 214, in a manner similar to that in step S176 of FIG. 21.

FIG. 22 is a flowchart illustrating the exemplary procedure of determining a message (continuation).

(S191) When it is determined at step S172 of FIG. 21 that the customer in question has not disappeared from the image, the message controller 250 determines whether the customer direction flag corresponding to the customer is “TRUE”. In other words, the message controller 250 determines whether a state in which the customer is facing the direction of the item placement area has already been detected from any of the images received during a period from when the process of step S171 is performed for the first time to when the current step is performed. The customer direction flag may be acquired, in a manner similar to that in step S174 of FIG. 21.

When the customer direction flag is “TRUE”, the process flow proceeds to step S192. When the customer direction flag is “FALSE”, the process flow proceeds to step S195.

(S192) the message controller 250 determines whether the contact flag corresponding to the customer is “TRUE”. In other words, the message controller 250 determines whether a state in which the customer has reached out his/her hand to the item has already been detected from any of the images received during a period from when the process of step S171 is performed for the first time to when the current step is performed. The contact flag may be acquired, in a manner similar to that in step S174 of FIG. 21.

When the contact flag is “TRUE”, the process flow proceeds to step S171 of FIG. 21. When the contact flag is “FALSE”, the process flow proceeds to step S193.

(S193) The contact determination unit 240 determines whether the customer is reaching out his/her hand to an item. As the method of determining whether the customer is reaching out his/her hand to an item, the method described referring to FIG. 9 is used.

On this occasion, the position of the customer's wrist may be acquired by reading the position information associated with “right wrist” or “left wrist” from the record of the customer in question in the skeletal information 121.

When the customer is reaching out his/her hand to an item, the process flow proceeds to step S194. When a customer is not reaching out his/her hand to an item, the process flow proceeds to step S171 of FIG. 21.

(S194) The message controller 250 sets the contact flag corresponding to the customer in question to “TRUE”. The contact flag may be set in the following manner. First, a record including the customer ID of the customer in question is retrieved from the item situation setting table 214. Subsequently, “TRUE” is set to the contact flag of the retrieved record.

(S195) The customer direction determination unit 230 determines whether the customer is facing the direction of the item placement area. The direction of the customer may be determined, for example, based on the distance in the XY plane between the customer's shoulders included in the skeletal information 121 received at step S171 of FIG. 21 or the positional relation of the Z-axis direction of the neck and the head, as described above.

When the customer is facing the direction of the item placement area, the process flow proceeds to step S196. When the customer is facing a direction other than the item placement area, the process flow proceeds to step S197.

In the exhibition management system 3, the direction of the customer is classified into any of “frontward” indicating the shooting direction of the sensor device 100, “backward” indicating the opposite direction of the shooting direction of the sensor device 100, and “sideways” which is perpendicular to the shooting direction of the sensor device 100 and parallel to the horizontal plane, for example. Needless to say, the classification of the direction of the customer is not limited to those described above. In addition, it is assumed in the procedures of FIGS. 20 to 23, the item placement is always located “frontward” of the customer seen from the sensor device 100. On this occasion, it is determined that the customer is facing the direction of the item placement area when the customer is facing “frontward”.

When there exists a plurality of item placement areas in a store, each of the item placement areas may be set to an arbitrary direction seen from a customer. In such cases, for example, a “direction” column illustrating the direction when an item placement area is set is added to the area information table 211.

(S196) The message controller 250 sets the customer direction flag corresponding to the customer in question to “TRUE”. The customer direction flag may be set in the following manner. First, a record including the customer ID of the customer in question is retrieved from the item situation setting table 214. Subsequently, the customer direction flag of the retrieved record is set to “TRUE” and registered.

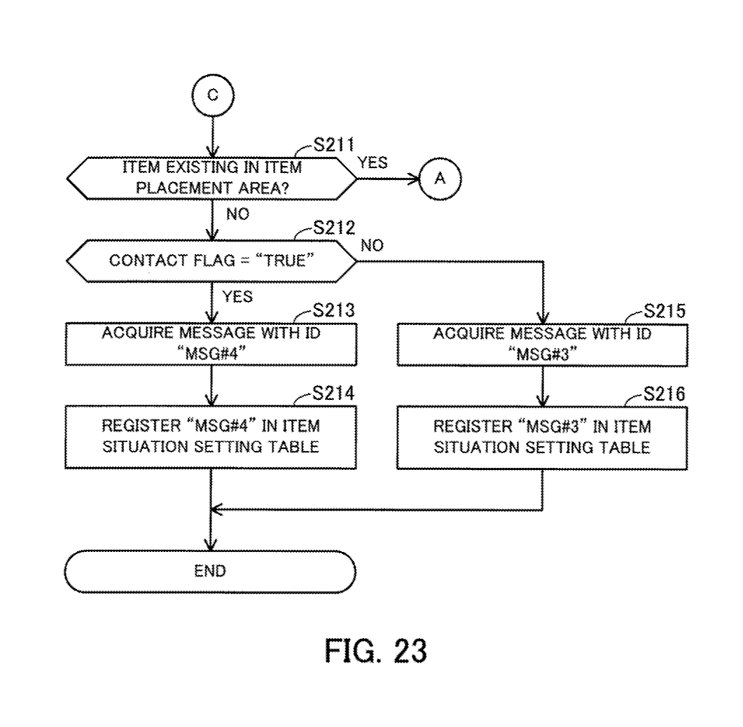

(S197) The contact determination unit 240 determines whether the customer is reaching out his/her hand to an item, in a manner similar to that in step S193. When the customer is reaching out his/her hand to an item, the process flow proceeds to step S198. When the customer is not reaching out his/her hand to an item, the process flow proceeds to step S211 of FIG. 23.

(S198) The message controller 250 sets the contact flag corresponding to the customer in question to “TRUE”, in a manner similar to that in step S194.

FIG. 23 is a flowchart illustrating the exemplary procedure of determining a message (continuation-2).

(S211) When it is determined at step S197 of FIG. 22 that the customer is not reaching out his/her hand to an item, the movement determination unit 220 determines whether the item exists in the corresponding item placement area, in a manner similar to that in step S12 of FIG. 20. When the item does not exist in the item placement area, the process flow proceeds to step S212. When the item exists in the item placement area, the process flow proceeds to step S171 of FIG. 21.

(S212) The message controller 250 determines whether the contact flag corresponding to the customer appearing in the image received at step S171 is “TRUE”, in a manner similar to that in step S192 of FIG. 22. In other words, the message controller 250 determines whether a state in which the customer′ hand has reached out his/her hand to the item has already been detected from any of the images received during a period from when the process of step S171 is performed for the first time to when the current step is performed.

When the contact flag is “TRUE”, the process flow proceeds to step S213. When the contact flag is “FALSE”, the process flow proceeds to step S215.

(S213) The message controller 250 generates a message corresponding to the message ID “MSG#4”, in a manner similar to that in step S14 of FIG. 20. The message corresponds to a situation of an item placement area when an item has been taken away by a criminal act by the customer.

(S214) The message controller 250 registers the message ID “MSG#4” in the item situation setting table 214, in a manner similar to that in step S176 of FIG. 21.

(S215) The message controller 250 generates a message corresponding to the message ID “MSG#3”, in a manner similar to that in step S14 of FIG. 20. The message corresponds to a situation of an item placement area when an item has fallen from a store shelf due to contact with a customer's baggage.

(S216) The message controller 250 registers the message ID “MSG#3” in the item situation setting table 214, in a manner similar to that in step S176.

In the flow illustrated in FIGS. 20 to 23, an example has been illustrated in which the message “MSG4” is registered when the result of determination is NO at step S172, NO at step S191, NO at step S195, NO at step S197, NO at step S211, or YES at step S212. However, an example of registering the message “MSG4” is not limited to those described above. For example, when the result at step S174 is NO, a process of determining whether the direction flag is “FALSE” and also the contact flag is “TRUE” is performed, and when the result is affirmative, the message “MSG4” may be registered, as another way of determination at the time when the customer disappeared (YES at step S172).

The correspondence between the message to be generated and the combination of the results of determining whether or not an item has been moved, whether the customer has reached out his/her hand to an item, and whether the customer is facing the direction of the item placement area is not limited to that described in the second embodiment. For example, the message controller 250 may generate a message other than the messages corresponding to “MSG#1” to “MSG#4”, when the result of determination at step S174 is NO.

In addition, the procedures of FIGS. 21 to 23 may be modified so that only the messages corresponding to the message IDs “MSG#3” and “MSG#4” are output. In this case, no message is output when it is determined at step S172 that a customer has disappeared from the image (when the customer has left the vicinity of the item placement area), regardless of whether or not the item exists in the item placement area. For example, when a customer is facing the direction of the item area, there is a possibility that the customer may stop in front of an item area and a sales clerk may notice that the customer has stopped. Therefore, outputting a warning message with low necessity may be prevented by not transmitting a message in such a situation, even when an item has been taken out from the item placement area. In addition, the aforementioned exhibition management system 3 may be modified to be a system dedicated to detecting a special situation such that the position of an item has been moved despite that the customer is not facing the direction of the item.

As has been described above, information processing by the first embodiment may be implemented by causing the monitoring apparatus 1 to execute a program, and information processing by the second embodiment may be implemented by causing the sensor device 100, the exhibition management apparatus 200, and the terminal apparatus 300 to execute a program. Such a program may be stored in a computer-readable storage medium (e.g., storage medium 37). A magnetic disk, an optical disk, a magneto-optical disk, a semiconductor memory or the like may be used as a storage medium, for example. An FD or an HDD may be used as a magnetic disk. A CD, a CD-R (Recordable)/RW (Rewritable), a DVD, or a DVD-R/RW may be used as an optical disk.

When distributing a program, a portable storage medium having stored the program thereon is provided, for example. The computer, for example, stores, in a storage device (e.g., HDD 203), a program stored in the portable storage medium or a program received from another computer, reads the program from the storage device and executes it. However, the program read from the portable storage medium may also be directly executed. In addition, at least a part of the information processing may be implemented by an electronic circuit such as a DSP (Digital Signal Processing), an ASIC, a PLD (Programmable Logic Device), or the like.

In one aspect, the situation of an item being exhibited may be accurately monitored.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A monitoring method comprising:
acquiring, by an information processing apparatus, a first piece of information indicating a detection result of whether or not an item placed in an item placement area has been moved, and a second piece of information indicating a detection result of a direction of a person located around the item placement area; and
determining, by the information processing apparatus, whether or not to output warning information, based on the first piece of information and the second piece of information.

2. The monitoring method according to claim 1, wherein, the determining includes outputting the warning information and determining contents of the warning information to be output based on the second piece of information, when the first piece of information indicates that the item has been moved.

3. The monitoring method according to claim 2, wherein
the acquiring includes further acquiring a third piece of information indicating a detection result of whether or not the person has reached out his/her hand to the item; and
the determining includes determining contents of the warning information to be output based on the second piece of information and the third piece of information, when the first piece of information indicates that the item has been moved.

4. The monitoring method according to claim 1, wherein the determining includes outputting the warning information, when the first piece of information indicates that the item has been moved and the second piece of information indicates that the person is not facing the direction of the item placement area.

5. The monitoring method according to claim 1, wherein the determining includes transmitting, when having determined to output the warning information, the warning information to a computer communicable with the information processing apparatus.

6. A monitoring apparatus comprising a processor configured to perform a process including:
acquiring a first piece of information indicating a detection result of whether or not an item placed in an item placement area has been moved, and a second piece of information indicating a detection result of a direction of a person located around the item placement area; and
determining whether or not to output warning information, based on the first piece of information and the second piece of information.

7. The monitoring apparatus according to claim 6, wherein the determining includes outputting the warning information and determining contents of the warning information to be output based on the second piece of information, when the first piece of information indicates that the item has been moved.

8. The monitoring apparatus according to claim 7, wherein
the acquiring includes further acquiring a third piece of information indicating a detection result of whether or not the person has reached out his/her hand to the item; and
the determining includes determining contents of the warning information to be output based on the second piece of information and the third piece of information, when the first piece of information indicates that the item has been moved.

9. The monitoring apparatus according to claim 6, wherein the determining includes outputting the warning information, when the first piece of information indicates that the item has been moved and the second piece of information indicates that the person is not facing the direction of the item placement area.

10. The monitoring apparatus according to claim 6, wherein the determining includes transmitting, when having determined to output the warning information, the warning information to a computer communicable with the information processing apparatus.

11. A non-transitory computer-readable storage medium storing a monitoring program that causes a computer to perform a process comprising:
acquiring a first piece of information indicating a detection result of whether or not an item placed in an item placement area has been moved, and a second piece of information indicating a detection result of a direction of a person located around the item placement area; and
determining whether or not to output warning information, based on the first piece of information and the second piece of information.
